(19) United States
(12) Patent Application Publication
(10) Pub. No.: US 2024/0405660 A1
(43) Pub. Date: Dec. 5, 2024

(54) MERGED SWITCHED-CAPACITOR PIEZOELECTRIC RESONATOR BASED POWER CONVERTER

(71) Applicant: Cornell University, Ithaca, NY (US)

(72) Inventors: Yuetao Hou, Ithaca, NY (US); Khurram K. Afridi, Ithaca, IN (US); Qijia Li, Ithaca, NY (US); Abdullah Saboor, Ithaca, NY (US)

(21) Appl. No.: 18/731,284

(22) Filed: Jun. 1, 2024

Related U.S. Application Data
(60) Provisional application No. 63/470,299, filed on Jun. 1, 2023.

(51) Int. Cl. H02M 1/00; H02M 3/158

(52) U.S. Cl. CPC H02M 1/0048; H02M 3/158

(57) ABSTRACT

A power converter includes a first stage, a second stage, and a piezoelectric-resonator electrically connected to the first stage and the second stage. At least one of the first stage and the second stage forms a switched capacitor converter circuit and includes a plurality of semiconductor switches and at least one flying capacitor. The power converter may be embodied as a unidirectional or bidirectional direct current-to-direct current (DC-DC), alternating current-to-direct current (AC-DC), or direct current-to-alternating current (DC-AC) power converter. The power converter may also include a control circuit configured to control operation of the semiconductor switches in a plurality of connected and open operation stages using variable or fixed switching frequencies.

The present application claims priority under 35 U.S.C. § 119 to, and the benefit of, U.S. Provisional Patent Application Ser. No. 63/470,299, entitled “MERGED SWITCHED-CAPACITOR PIEZOELECTRIC RESONATOR BASED POWER CONVERTER,” which was filed on Jun. 1, 2023, the entirety of which is expressly incorporated herein by reference.

### FIELD OF THE DISCLOSURE

The present disclosure relates generally to power converters and, more particularly, to direct current-to-direct current (DC-DC), alternating current-to-direct current (AC-DC), and direct current-to-alternating current (DC-AC) power converters including piezoelectric-resonators.

### BACKGROUND

Power converters are electronic devices or circuits configured to convert a direct current (DC) to another direct current (DC), an alternating current (AC) to a direct current (DC), or a direct current (DC) to an alternating current (AC). Depending on the implementation, such power converters may include a varying number of converter stages including a varying number of semiconductor switches and other components, including magnetic components.

Magnetic components have become the bottleneck for the miniaturization and integration of power converters. Recently, due to their high energy storage density, piezoelectric materials have emerged as a promising candidate to replace magnetics. Past research has explored topologies for inductor-less piezoelectric-resonator-based dc-dc converters that achieve relative high power density and relative high efficiency by utilizing piezoelectric resonators in an efficient manner. For example, one embodiments of such a power converter 200 is illustrated schematically in FIG. 2. The baseline converter 200 operates relatively efficiently when the voltage conversion ratio is low. However, because the piezoelectric resonator is directly exposed to the input and output voltages of the baseline converter 200, the amplitude of vibration of the piezoelectric resonator (represented in the equivalent circuit model by the current of the inductive branch of the piezoelectric resonator) increases in direct proportion to an increase in input voltage. However, such an increased inductive branch current may increase losses and degrade converter efficiency as the voltage conversion ratio (i.e., the difference between the input and the output voltage) of the baseline converter 200 increases.

### SUMMARY

According to an aspect of the present disclosure, a power converter may include a first stage, a second stage, and a piezoelectric-resonator. The first stage may include a first terminal electrically connected to an input of the power converter and a second terminal electrically connected to a first output of the power converter. The second stage may include a first terminal electrically connected to the first output of the power converter and a second terminal electrically connected to a second output of the power converter. The piezoelectric-resonator may include a first terminal electrically connected to a third terminal of the first stage and a second terminal electrically connected to a third terminal of the second stage. Additionally, at least one of the first stage or the second stage may be embodied as a switched capacitor converter circuit including a plurality of semiconductor switches and at least one flying capacitor.

In some embodiments, the first stage may be embodied as the switched capacitor circuit, and the second stage may be embodied as a pair of semiconductor switches. In such embodiments, the third terminal of the second stage may be located between the pair of semiconductor switches of the second stage.

Additionally, in some embodiments, the first stage may be embodied as the switched capacitor circuit, and the second stage may be embodied as a pair of diodes. Such embodiments, the third terminal of the second stage may be located between the pair of diodes switches of the second stage.

In some embodiments, the second stage may be embodied as the switched capacitor circuit, and the first stage may be embodied as a pair of semiconductor switches. In such embodiments, the third terminal of the first stage may be located between the pair of semiconductor switches of the first stage.

Additionally, in some embodiments, the second stage may be embodied as the switched capacitor circuit, and the first stage may be embodied as a pair of didoes. In such embodiments, the third terminal of the first stage may be located between the pair of diodes of the first stage.

In some embodiments, the power converter may include a first pair of semiconductor switches and a second pair of semiconductor switches. In such embodiments, the first pair of semiconductor switches may include a first semiconductor switch and a second semiconductor switch electrically connected to each other at a first electrical connection node. Additionally, the second pair of semiconductor switches may include a third semiconductor switch and a fourth semiconductor switch electrically connected to each other at a second electrical connection node. The second semiconductor switch may be electrically connected to the third semiconductor switch at a third electrical connection node. In such embodiments, the at least one flying capacitor may include a first flying capacitor having a first terminal electrically connected to the first electrical connection node and a second terminal electrically connected to the second electrical connection node.

Additionally, in some embodiments, the power converter may further include a fifth semiconductor switch connected to the first semiconductor switch at a fourth electrical connection node and a sixth semiconductor switch connected to the fourth semiconductor switch at a fifth electrical connection node. In such embodiments, the at least one flying capacitor may further include a second flying capacitor having a first terminal electrically connected to the fourth electrical connection node and a second terminal electrically connected to the fifth electrical connection node.

In some embodiments, the power converter may also include a third pair of semiconductor switches and a fourth pair of semiconductor switches. The third pair of semiconductor switches may include a fifth semiconductor switch and a sixth semiconductor switch electrically connected to each other at a fourth electrical connection node. The first semiconductor switch may be electrically connected to the sixth semiconductor switch at a fifth electrical connection node. The fourth pair of semiconductor switches may include a seventh semiconductor switch and a eighth semiconductor switch electrically connected to each other at a sixth electrical connection node. The fourth semiconductor switch may be electrically connected to the sixth semiconductor switch at a seventh electrical connection node. In such embodiments, the at least one flying capacitor further may include (i) a second flying capacitor having a first terminal electrically connected to the fifth electrical connection node and a second terminal electrically connected to the seventh electrical connection node and (ii) a third flying capacitor having a first terminal electrically connected to the fourth electrical connection node and a second terminal electrically connected to the sixth electrical connection node.

In some embodiments, each semiconductor switch may be embodied as a field effect transistor (FET). For example, each semiconductor switch may be embodied as a metal oxide semiconductor field effect transistor (MOSFET). In some embodiments, each semiconductor switch may be embodied as a high-electron-mobility transistor (HEMT).

Further, in some embodiments, the power converter may further include a control circuit electrically connected to each semiconductor switch and configured to control operation of the semiconductor switches. In such embodiments, the control circuit may be configured to control operation of the semiconductor switches in a plurality of operation stages.

According to another aspect of the present disclosure, a power converter may include a first stage, a second stage, and a piezoelectric-resonator. The first stage may include a first terminal electrically connected to an input of the power converter and a second terminal electrically connected to a first output of the power converter. The second stage may include a first terminal electrically connected to a second output of the power converter and a second terminal electrically connected to the first output of the power converter. The piezoelectric-resonator may include a first terminal electrically connected to a third terminal of the first stage and a second terminal electrically connected to a third terminal of the second stage. Additionally, at least one of the first stage or the second stage may be embodied as a switched capacitor converter circuit including a plurality of semiconductor switches and at least one flying capacitor.

Additionally, in some embodiments, the first stage may be embodied as the switched capacitor circuit, and the second stage may be embodied as a pair of diodes. Such embodiments, the third terminal of the second stage may be located between the pair of diodes switches of the second stage.

In some embodiments, the second stage may be embodied as the switched capacitor circuit, and the first stage may be embodied as a pair of semiconductor switches. In such embodiments, the third terminal of the first stage may be located between the pair of semiconductor switches of the first stage.

Additionally, in some embodiments, the second stage may be embodied as the switched capacitor circuit, and the first stage may be embodied as a pair of didoes. In such embodiments, the third terminal of the first stage may be located between the pair of diodes of the first stage.

In some embodiments, the power converter may include a first pair of semiconductor switches and a second pair of semiconductor switches. In such embodiments, the first pair of semiconductor switches may include a first semiconductor switch and a second semiconductor switch electrically connected to each other at a first electrical connection node. Additionally, the second pair of semiconductor switches may include a third semiconductor switch and a fourth semiconductor switch electrically connected to each other at a second electrical connection node. The second semiconductor switch may be electrically connected to the third semiconductor switch at a third electrical connection node. In such embodiments, the at least one flying capacitor may include a first flying capacitor having a first terminal electrically connected to the first electrical connection node and a second terminal electrically connected to the second electrical connection node.

Additionally, in some embodiments, the power converter may further include a fifth semiconductor switch connected to the first semiconductor switch at a fourth electrical connection node and a sixth semiconductor switch connected to the fourth semiconductor switch at a fifth electrical connection node. In such embodiments, the at least one flying capacitor may further include a second flying capacitor having a first terminal electrically connected to the fourth electrical connection node and a second terminal electrically connected to the fifth electrical connection node.

In some embodiments, the power converter may also include a third pair of semiconductor switches and a fourth pair of semiconductor switches. The third pair of semiconductor switches may include a fifth semiconductor switch and a sixth semiconductor switch electrically connected to each other at a fourth electrical connection node. The first semiconductor switch may be electrically connected to the sixth semiconductor switch at a fifth electrical connection node. The fourth pair of semiconductor switches may include a seventh semiconductor switch and a eighth semiconductor switch electrically connected to each other at a sixth electrical connection node. The fourth semiconductor switch may be electrically connected to the sixth semiconductor switch at a seventh electrical connection node. In such embodiments, the at least one flying capacitor further may include (i) a second flying capacitor having a first terminal electrically connected to the fifth electrical connection node and a second terminal electrically connected to the seventh electrical connection node and (ii) a third flying capacitor having a first terminal electrically connected to the fourth electrical connection node and a second terminal electrically connected to the sixth electrical connection node.

In some embodiments, each semiconductor switch may be embodied as a field effect transistor (FET). For example, each semiconductor switch may be embodied as a metal oxide semiconductor field effect transistor (MOSFET). In some embodiments, each semiconductor switch may be embodied as a high-electron-mobility transistor (HEMT).

Further, in some embodiments, the power converter may further include a control circuit electrically connected to each semiconductor switch and configured to control operation of the semiconductor switches. In such embodiments, the control circuit may be configured to control operation of the semiconductor switches in a plurality of operation stages.

According to a further aspect of the present disclosure, a power converter may include a first stage, a second stage, and a piezoelectric-resonator. The first stage may include a first terminal electrically connected to an input of the power converter and a second terminal electrically connected to a first output of the power converter. The second stage may include a first terminal electrically connected to a second output of the power converter. The piezoelectric-resonator may include (i) a first terminal electrically connected to a third terminal of the first stage and a second terminal of the second stage and (ii) a second terminal electrically connected to a first terminal of the second stage and the second output of the power converter. Additionally, the first stage may be embodied as a switched capacitor converter circuit including a plurality of semiconductor switches and at least one flying capacitor and wherein the second stage comprises a pair of semiconductor switches.

In some embodiments, the power converter may also include a first pair of semiconductor switches and a second pair of semiconductor switches. In such embodiments, the first pair of semiconductor switches may include a first semiconductor switch and a second semiconductor switch electrically connected to each other at a first electrical connection node. Additionally, the second pair of semiconductor switches may include a third semiconductor switch and a fourth semiconductor switch electrically connected to each other at a second electrical connection node. The second semiconductor switch may be electrically connected to the third semiconductor switch at a third electrical connection node. In such embodiments, the at least one flying capacitor may include a first flying capacitor having a first terminal electrically connected to the first electrical connection node and a second terminal electrically connected to the second electrical connection node.

Additionally, in some embodiments, the power converter may further include a fifth semiconductor switch connected to the first semiconductor switch at a fourth electrical connection node and a sixth semiconductor switch connected to the fourth semiconductor switch at a fifth electrical connection node. In such embodiments, the at least one flying capacitor may further include a second flying capacitor having a first terminal electrically connected to the fourth electrical connection node and a second terminal electrically connected to the fifth electrical connection node.

In some embodiments, the power converter may also include a third pair of semiconductor switches and a fourth pair of semiconductor switches. The third pair of semiconductor switches may include a fifth semiconductor switch and a sixth semiconductor switch electrically connected to each other at a fourth electrical connection node. The first semiconductor switch may be electrically connected to the sixth semiconductor switch at a fifth electrical connection node. The fourth pair of semiconductor switches may include a seventh semiconductor switch and a eighth semiconductor switch electrically connected to each other at a sixth electrical connection node. The fourth semiconductor switch may be electrically connected to the sixth semiconductor switch at a seventh electrical connection node. In such embodiments, the at least one flying capacitor further may include (i) a second flying capacitor having a first terminal electrically connected to the fifth electrical connection node and a second terminal electrically connected to the seventh electrical connection node and (ii) a third flying capacitor having a first terminal electrically connected to the fourth electrical connection node and a second terminal electrically connected to the sixth electrical connection node.

In some embodiments, each semiconductor switch may be embodied as a field effect transistor (FET). For example, each semiconductor switch may be embodied as a metal oxide semiconductor field effect transistor (MOSFET). In some embodiments, each semiconductor switch may be embodied as a high-electron-mobility transistor (HEMT).

Further, in some embodiments, the power converter may further include a control circuit electrically connected to each semiconductor switch and configured to control operation of the semiconductor switches. In such embodiments, the control circuit may be configured to control operation of the semiconductor switches in a plurality of operation stages.

According to an additional aspect of the present disclosure, a power converter may include a first stage, a second stage, and a piezoelectric-resonator. The first stage may include a first terminal electrically connected to an input of the power converter and a second terminal electrically connected to a first output of the power converter. The second stage may include a second stage having a first terminal electrically connected to a second output of the power converter. The piezoelectric-resonator may include (i) a first terminal electrically connected to a third terminal of the first stage and a second terminal of the second stage and (ii) a second terminal electrically connected to the first output of the power converter. Additionally, the first stage may be embodied as a switched capacitor converter circuit including a plurality of semiconductor switches and at least one flying capacitor and wherein the second stage comprises a pair of semiconductor switches.

In some embodiments, the power converter may also include a first pair of semiconductor switches and a second pair of semiconductor switches. In such embodiments, the first pair of semiconductor switches may include a first semiconductor switch and a second semiconductor switch electrically connected to each other at a first electrical connection node. Additionally, the second pair of semiconductor switches may include a third semiconductor switch and a fourth semiconductor switch electrically connected to each other at a second electrical connection node. The second semiconductor switch may be electrically connected to the third semiconductor switch at a third electrical connection node. In such embodiments, the at least one flying capacitor may include a first flying capacitor having a first terminal electrically connected to the first electrical connection node and a second terminal electrically connected to the second electrical connection node.

Additionally, in some embodiments, the power converter may further include a fifth semiconductor switch connected to the first semiconductor switch at a fourth electrical connection node and a sixth semiconductor switch connected to the fourth semiconductor switch at a fifth electrical connection node. In such embodiments, the at least one flying capacitor may further include a second flying capacitor having a first terminal electrically connected to the fourth electrical connection node and a second terminal electrically connected to the fifth electrical connection node.

In some embodiments, the power converter may also include a third pair of semiconductor switches and a fourth pair of semiconductor switches. The third pair of semiconductor switches may include a fifth semiconductor switch and a sixth semiconductor switch electrically connected to each other at a fourth electrical connection node. The first semiconductor switch may be electrically connected to the sixth semiconductor switch at a fifth electrical connection node. The fourth pair of semiconductor switches may include a seventh semiconductor switch and a eighth semiconductor switch electrically connected to each other at a sixth electrical connection node. The fourth semiconductor switch may be electrically connected to the sixth semiconductor switch at a seventh electrical connection node. In such embodiments, the at least one flying capacitor further may include (i) a second flying capacitor having a first terminal electrically connected to the fifth electrical connection node and a second terminal electrically connected to the seventh electrical connection node and (ii) a third flying capacitor having a first terminal electrically connected to the fourth electrical connection node and a second terminal electrically connected to the sixth electrical connection node.

In some embodiments, each semiconductor switch may be embodied as a field effect transistor (FET). For example, each semiconductor switch may be embodied as a metal oxide semiconductor field effect transistor (MOSFET). In some embodiments, each semiconductor switch may be embodied as a high-electron-mobility transistor (HEMT).

Further, in some embodiments, the power converter may further include a control circuit electrically connected to each semiconductor switch and configured to control operation of the semiconductor switches. In such embodiments, the control circuit may be configured to control operation of the semiconductor switches in a plurality of operation stages.

According to yet a further aspect of the present disclosure, a power converter may include a first pair of semiconductor switches and a second pair of semiconductor switches. The first pair of semiconductor switches may include a first semiconductor switch and a second semiconductor switch electrically connected to each other at a first electrical connection node. The second pair of semiconductor switches may include a third semiconductor switch and a fourth semiconductor switch electrically connected to each other at a second electrical connection node. The second semiconductor switch is also electrically connected to the fourth semiconductor switch at a third electrical connection node. Additionally, the power converter may include a piezoelectric-resonator having a first terminal electrically connected to the third electrical connection node and a second terminal electrically coupled to an output terminal of the power converter.

In some embodiments, the power converter may further include a capacitor having a first terminal electrically connected to the first electrical connection node and a second terminal electrically connected to the second electrical connection node. Additionally, in some embodiments, the first semiconductor switch may include a source terminal electrically connected to the first electrical connection node and a drain terminal electrically connected to an input terminal of the power converter. The second semiconductor switch may include a source terminal electrically connected to the third electrical connection node and a drain terminal electrically connected to the first electrical connection node. The third semiconductor switch may include a source terminal electrically connected to the output terminal of the power converter and a drain terminal electrically connected to the second electrical connection node, and the fourth semiconductor switch may include a source terminal electrically connected to the second electrical connection node and a drain terminal electrically connected to the third electrical connection node. In such embodiments, the power converter may further include a capacitor having a first terminal electrically connected to the first electrical connection node and a second terminal electrically connected to the second electrical connection node.

Additionally, in some embodiments, the power converter may further include a first diode electrically connected to a second diode at a fourth electrical connection node. In such embodiments, the second terminal of the piezoelectric-resonator may be electrically connected to the fourth electrical connection node. In such embodiments, the first diode may have a first terminal electrically connected to the fourth electrical connection node and a second terminal electrically connected to a first output terminal of the power converter. Additionally, in such embodiments, the second diode may include a first terminal electrically connected to a second output terminal of the power converter and a second terminal electrically connected to the fourth electrical connection node. Furthermore, in some embodiments, the first terminal of the first diode may be embodied as an anode terminal, the second terminal of the first diode may be embodied as a cathode terminal, the first terminal of the second diode may be embodied as an anode terminal, and the second terminal of the second diode may be embodied as a cathode terminal.

In some embodiments, each semiconductor switch of the first and second pairs of semiconductor switches may be embodied as a field effect transistor (FET). For example, each semiconductor switch may be embodied as a metal oxide semiconductor field effect transistor (MOSFET). In some embodiments, each semiconductor switch may be embodied as a high-electron-mobility transistor (HEMT).

Further, in some embodiments, the power converter may further include a control circuit electrically connected to each semiconductor switch and configured to control operation of the semiconductor switches. In such embodiments, the control circuit may be configured to control operation of the semiconductor switches in a plurality of operation stages. For example, the plurality of operation stages may include a plurality of connected operation stages in which the piezoelectric-resonator is electrically coupled across an input of the power converter, an output of the power converter, or a capacitor of the power converter and a plurality of open operation stages in which the piezoelectric-resonator is not coupled across the input of the power converter, the output of the power converter, or the capacitor of the power converter. In some embodiments, the plurality of connected operation stages may include at least three connected operation stages and the plurality of open operation stages may include at least four open operation stages.

Additionally, in some embodiments, when in a first connected operation stage, the first semiconductor switch and the fourth semiconductor switch of the power converter may be on and the second semiconductor switch and the third semiconductor switch of the power converter may be off. Additionally, when in a second connected operation stage, the third semiconductor switch and the fourth semiconductor switch of the power converter may be on and the first semiconductor switch and the second semiconductor switch of the power converter may be off. Further, when in a third connected operation stage, the second semiconductor switch and the third semiconductor switch of the power converter may be on and the first semiconductor switch and the fourth semiconductor switch of the power converter may be off. Additionally, when in any of the four open operation stages, each of the first, second, third, and fourth semiconductor switch of the power converter is off.

According to another aspect of the present disclosure, a power converter may include a first semiconductor switch, a second semiconductor switch, a third semiconductor switch, a fourth semiconductor switch, a capacitor, a first diode, a second diode, and a piezoelectric-resonator. The first semiconductor switch may have a source terminal electrically connected to a first electrical connection node and a drain terminal electrically connected to an input terminal of the power converter. The second semiconductor switch may have a source terminal electrically connected to a third electrical connection node and a drain terminal electrically connected to the first electrical connection node. The third semiconductor switch may have a source terminal electrically connected to a first output terminal of the power converter and a drain terminal electrically connected to a second electrical connection node. The fourth semiconductor switch may have a source terminal electrically connected to the second electrical connection node and a drain terminal electrically connected to the third electrical connection node. The capacitor may include a first terminal electrically connected to the first electrical connection node and a second terminal electrically connected to the second electrical connection node. The first diode may include a first terminal electrically connected to the first output terminal and a second terminal electrically connected to a fourth electrical connection node. The second diode may include a first terminal electrically connected to a second output terminal of the power converter and a second terminal electrically connected to the fourth electrical connection node. And, the piezoelectric-resonator may have a first terminal electrically connected to the third electrical connection node and a second terminal electrically coupled to the fourth electrical connection node.

In some embodiments, the power converter may further include a control circuit electrically connected to each semiconductor switch and configured to control operation of the semiconductor switches. In such embodiments, the control circuit may be configured to control operation of the semiconductor switches in a plurality of operation stages. For example, the plurality of operation stages may include a plurality of connected operation stages in which the piezoelectric-resonator is electrically coupled across an input of the power converter, an output of the power converter, or a capacitor of the power converter and a plurality of open operation stages in which the piezoelectric-resonator is not coupled across the input of the power converter, the output of the power converter, or the capacitor of the power converter. In some embodiments, the plurality of connected operation stages may include at least three connected operation stages and the plurality of open operation stages may include at least four open operation stages.

Additionally, in some embodiments, when in a first connected operation stage, the first semiconductor switch and the fourth semiconductor switch of the power converter may be on and the second semiconductor switch and the third semiconductor switch of the power converter may be off. Additionally, when in a second connected operation stage, the third semiconductor switch and the fourth semiconductor switch of the power converter may be on and the first semiconductor switch and the second semiconductor switch of the power converter may be off. Further, when in a third connected operation stage, the second semiconductor switch and the third semiconductor switch of the power converter may be on and the first semiconductor switch and the fourth semiconductor switch of the power converter may be off. Additionally, when in any of the four open operation stages, each of the first, second, third, and fourth semiconductor switch of the power converter is off.

In some embodiments, the first terminal of the first diode may be embodied as an anode terminal, the second terminal of the first diode may be embodied as a cathode terminal, the first terminal of the second diode may be embodied as an anode terminal, and the second terminal of the second diode may be embodied as a cathode terminal.

In some embodiments, each semiconductor switch of the first and second pairs of semiconductor switches may be embodied as a field effect transistor (FET). For example, each semiconductor switch may be embodied as a metal oxide semiconductor field effect transistor (MOSFET). In some embodiments, each semiconductor switch may be embodied as a high-electron-mobility transistor (HEMT).

According to yet a further aspect of the present disclosure, a method for controlling operation of a power converter including a first stage, a second stage and a piezoelectric-resonator, wherein the first stage includes a plurality of semiconductor switches and at least one flying capacitor may include generating, by a controller of the power converter, switching signals at a fixed switching frequency; supplying, by the controller, the switching signals to at the first stage; and operating, by the first stage, the plurality semiconductor switches at the fixed switching frequency.

In such embodiments, operating the plurality of semiconductor switches may include controlling a switching operation of the semiconductor switches in a plurality of operation modes including at least seven connected operation modes in which the piezoelectric-resonator is electrically coupled across an input of the power converter, an output of the power converter, or a capacitor of the power converter and at least five open operation modes in which the piezoelectric-resonator is not coupled across the input of the power converter, the output of the power converter, or the capacitor of the power converter

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified electrical schematic of an embodiment of a merged switched-capacitor piezoelectric-resonator-based power converter;

FIG. 2 is a simplified electrical schematic of a prior art baseline power converter;

FIG. 3 is a simplified electrical schematic of another embodiment of the merged switched-capacitor piezoelectric-resonator-based power converter of FIG. 1;

FIG. 4 is a simplified electrical schematic of another embodiment of the merged switched-capacitor piezoelectric-resonator-based power converter of FIG. 1;

FIG. 5 is a simplified electrical schematic of another embodiment of the merged switched-capacitor piezoelectric-resonator-based power converter of FIG. 1;

FIG. 6 is a simplified electrical schematic of a particular embodiment of the merged switched-capacitor piezoelectric-resonator-based power converter of FIG. 1;

FIG. 7 is a simplified flow diagram of an embodiment of a method for controlling the power converter of FIG. 6 using a variable frequency;

FIG. 8 is a simplified timing diagram showing stead-state waveforms of the power converter of FIG. 6 using the variable frequency control methodology of FIG. 7;

FIGS. 9A-9G are simplified electrical schematics of the power converter of FIG. 6 during various charging operating states, with each state corresponding to a waveform shown in FIG. 7;

FIGS. 10A-10G are simplified electrical schematics of the power converter of FIG. 6 during various discharging operating states, with each state corresponding to a waveform shown in FIG. 7;

FIG. 11 is a simplified graph illustrating a comparison between the baseline power converter of FIG. 2 and the power converter of FIG. 6 in terms of the amplitude of the effective current through the inductive branch of the piezoelectric-resonator I_{L} versus the voltage conversion ratio of the corresponding converter with fixed Vₒᵤₜ and a switching frequency f=118 kHz;

FIG. 12 is a simplified graph illustrating a comparison between the baseline power converter of FIG. 2 and the power converter of FIG. 6 in terms of analytically computed (solid lines) and simulated (dotted points) efficiency versus the voltage conversion ratio of the corresponding converter with fixed Vₒᵤₜ and a switching frequency f=118 kHz;

FIG. 13 is a simplified flow diagram of an embodiment of a method for controlling the power converter of FIG. 6 using a fixed frequency;

FIG. 14 is a simplified timing diagram showing stead-state waveforms of the power converter of FIG. 6 using the fixed frequency control methodology of FIG. 7;

FIGS. 15A-15L are simplified electrical schematics of the power converter of FIG. 6 during various charging operating states, with each state corresponding to a waveform shown in FIG. 14;

FIGS. 16A-16L are simplified electrical schematics of the power converter of FIG. 6 during various discharging operating states, with each state corresponding to a waveform shown in FIG. 14;

FIG. 17 is a simplified graph of a state plane diagram of the baseline converter of FIG. 2;

FIG. 18 is a simplified graph of a state plane diagram of the power converter of FIG. 6 using the variable frequency control methodology of FIGS. 7 and 8;

FIG. 19 is a simplified graph of a state plane diagram of the power converter of FIG. 6 using the fixed frequency control methodology of FIGS. 13 and 14;

FIG. 20 is a simplified graph of predicted inductive motional branch current I_{LMAX} for the baseline converter of FIG. 2, the power converter of FIG. 6 using the variable frequency control methodology of FIGS. 7 and 8, and the power converter of FIG. 6 using the fixed frequency control methodology of FIGS. 13 and 14;

FIG. 21 is a simplified graph of output voltage based on switching frequency for the baseline converter of FIG. 2 and the power converter of FIG. 6 using the fixed frequency control methodology of FIGS. 13 and 14; and

FIGS. 22A-22N are simplified electric schematics of variant embodiments of the power converter of FIG. 6.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. Furthermore, the use of ordered terms such as “first” and “second” are used for reference purposes only with the understanding that such designations may be swapped or otherwise interchanged in some of the circuits described below.

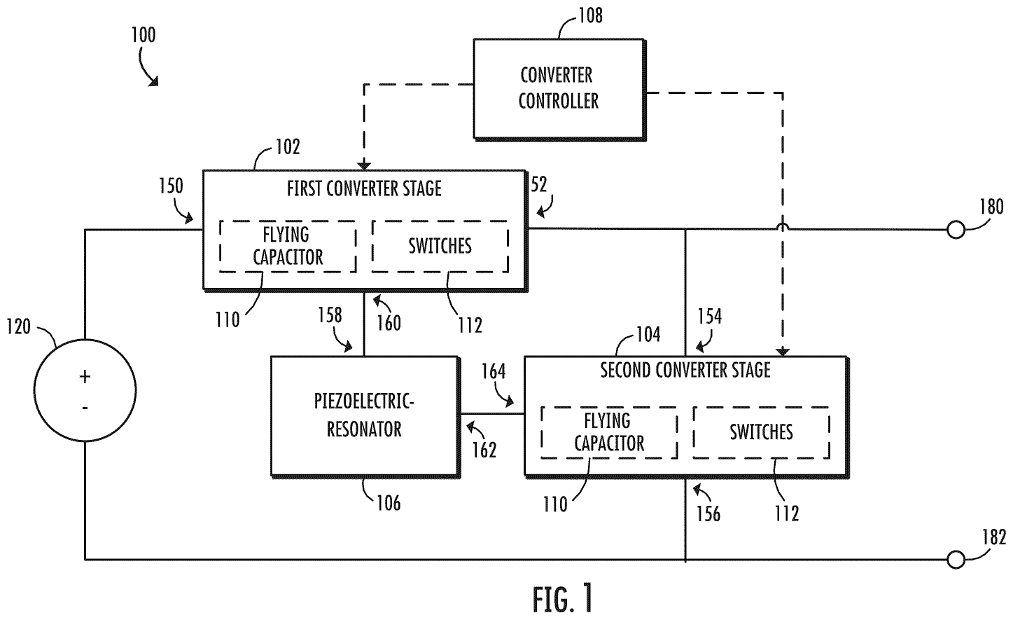

Referring now to FIG. 1, an illustrative merged switched-capacitor piezoelectric resonator DC-DC power converter 100 includes a first converter stage 102, a second converter stage 104, and a piezoelectric-resonator 106. The power converter 100 also includes a converter controller 108 configured to generate switching signals at a variable or fixed frequency, depending on the embodiment, to control one or both of the converter stages 102, 104. One or both of the converter stages 102, 104 may include a flying (switched) capacitor 110 and a set of semiconductor switches 112 (e.g., transistors). Alternatively, in some embodiments, one of the converter stages 102, 104 may be embodied as a diode bridge and/or other circuit components.

The power converter 100, and other embodiments of the power converter 100 described below, are configured to achieve relatively high and flat efficiency across a wide voltage conversion ratio. In the described converters, the switched capacitor 110 and the piezoelectric-resonator 106 are combined to form a multi-level structure and controlled in a manner to achieve the relatively high efficiency across a wide voltage conversion ratio. Additionally, the disclosed power converters and associated control strategies enables the switched capacitor 110 to be soft-charged by the current from the piezoelectric-resonator 106 and achieves zero-voltage-switching (ZVS) for all its switches.

Various circuit topologies of the power converter 100 are described below and including the first converter stage, the second converter stage, and the piezoelectric-resonator 106 electrically connected to each other in different configurations. For example, in the illustrative embodiment of FIG. 1, the first converter stage 102 has a first terminal 150 electrically coupled to an input source 120 of the power converter 100 and a second terminal 152 electrically connected to a first output 180 of the power converter 100. The second converter stage 104 has a first terminal 154 electrically connected to the first converter output 180 of the power converter 100 and a second terminal 156 electrically connected to a second converter output 182 of the power converter 100. The piezoelectric-resonator 106 has a first terminal 158 electrically connected to a third terminal 160 of the first converter stage 102 and a second terminal 162 electrically connected to a third terminal 164 of the second converter stage 104. As discussed above, either or both of the first and second converter stages may be embodied as a switched capacitor converter circuit and include the switched capacitor 110 and a set of semiconductor switches 112.

In another embodiment as shown in FIG. 3, the first converter stage 102 may have a first terminal electrically connected to the input 120 of the power converter 100 and a second terminal electrically connected to a first output of the power converter 100. In such embodiments, the second converter stage 104 may have a first terminal electrically connected to a second output of the power converter 100 and a second terminal electrically connected to the first output of the power converter 100. Additionally, the piezoelectric-resonator 106 may have a first terminal electrically connected to a third terminal of the first converter stage 102 and a second terminal electrically connected to a third terminal of the second converter stage 104. It should be appreciated that in each of the embodiments of FIGS. 1 and 3, both terminals of the piezoelectric-resonator 106 are connected to a switched-capacitor network in those embodiments in which both the first and second converter stages 102, 104 are embodied as switched-capacitor networks.

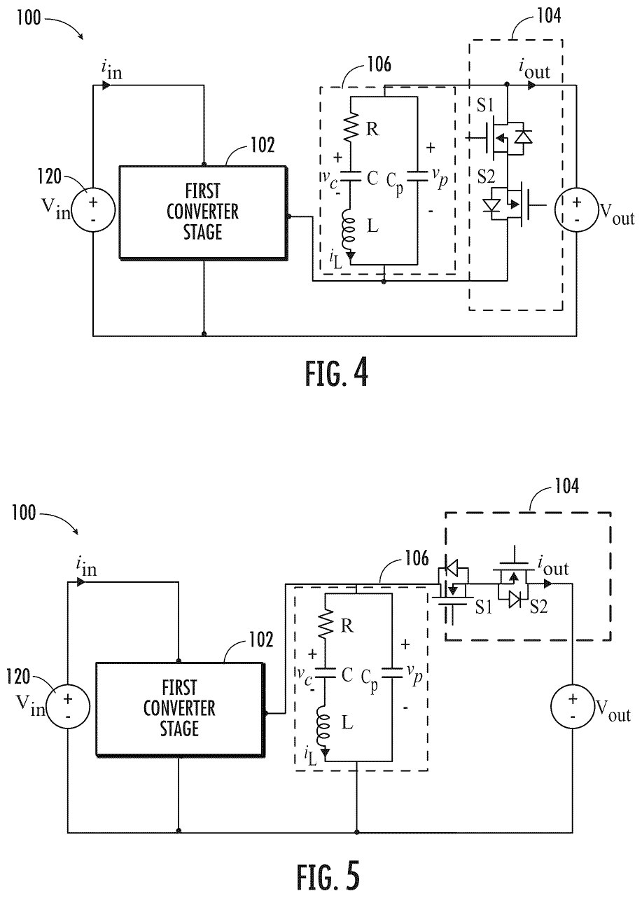

Referring now to FIG. 4, in another embodiment of the power converter 100, the first converter stage 102 may have a first terminal electrically connected to the input 120 of the power converter 100 and a second terminal electrically connected to a first output of the power converter 100. The second converter stage 104 may have a first terminal electrically connected to a second output of the power converter 100. Additionally, the piezoelectric-resonator 106 may have (i) a first terminal electrically connected to a third terminal of the first converter stage 102 and a second terminal of the second converter stage 104 and (ii) a second terminal electrically connected to a first terminal of the second converter stage 104 and the second output of the power converter 100.

In another embodiment as shown in FIG. 5, the first converter stage 102 may have a first terminal electrically connected to the input 120 of the power converter 100 and a second terminal electrically connected to a first output of the power converter 100. The second converter stage may have a first terminal electrically connected to a second output of the power converter 100. Additionally, the piezoelectric-resonator 106 may have (i) a first terminal electrically connected to a third terminal of the first converter stage 102 and a second terminal of the second converter stage 104 and (ii) a second terminal electrically connected to the first output of the power converter 100. It should be appreciated that in each of the embodiments of FIGS. 4 and 5, one terminal of the piezoelectric-resonator 106 is connected to the first converter stage embodied as a switched-capacitor network and other terminal is connected to a four-quadrant (bidirectional current carrying and bidirectional voltage blocking) switch formed by two back-to-back connected MOSFETs (S1 and S2).

The embodiments illustrated in FIGS. 1 and 3-5 and described above are generalized versions of four different embodiments of a merged switched-capacitor piezoelectric-resonator based dc-dc converter. Those generalized embodiments represent four families of merged switched-capacitor piezoelectric-resonator based dc-dc converter architectures. However, as illustrated in FIGS. 31A-31N and described below, other merged switched-capacitor piezoelectric-resonator based DC-DC, AC-DC, and DC-AC converters can be created from each of the four embodiment illustrated in FIGS. 1 and 3-5 by modifying the switched-capacitor networks of the first and/or second converter stages 102, 104 (e.g., modifying the number of flying capacitors 110 and/or semiconductor switches 112). It should be appreciated that, in order to maintain a relatively high converter efficiency, the flying capacitor 110 of the first and/or second converter stages should be soft charged and discharged by an effective current source. A common feature of all the embodiments of FIGS. 1 and 3-5 is the power converter's 100 ability to soft charge the flying capacitors 110. The current of the motional branch of the piezoelectric resonator—106 can be used as an equivalent current source to charge and discharge the flying capacitor 110 of the switched-capacitor network(s) (i.e., of the first and/or second converter stages 102, 104).

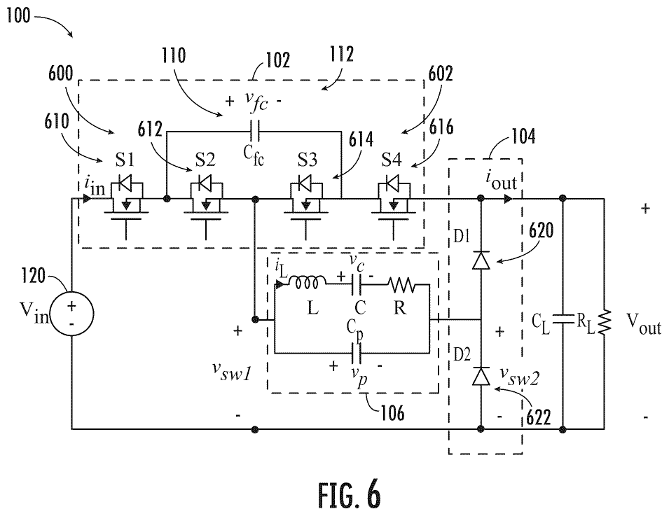

Referring now to FIG. 6, one particular embodiment of the power converter 100 of FIG. 1 is shown. In the illustrative embodiment, the first converter stage 102 includes a first pair of semiconductor switches 600 and a second pair of semiconductor switches 602. The first pair of semiconductor switches 600 includes a first semiconductor switch 610 and a second semiconductor switch 612 electrically connected to each other at a first electrical connection node. The second pair of semiconductor switches 602 includes a third semiconductor switch 614 and a fourth semiconductor switch 616 electrically connected to each other at a second electrical connection node. Additionally, the second semiconductor switch 612 is electrically connected to the third semiconductor 614 switch at a third electrical connection node.

The second converter stage 104 includes a pair of diodes 620, 622 connected to each other at an electrical connection node that is also coupled to the piezoelectric-resonator 106 as shown. Additionally, the flying or switched capacitor 110 has a first terminal electrically connected to the first electrical connection node between the first and second semiconductor switches 610, 612 and a second terminal electrically connected to the second electrical connection node between the third and fourth semiconductor switches 614, 616.

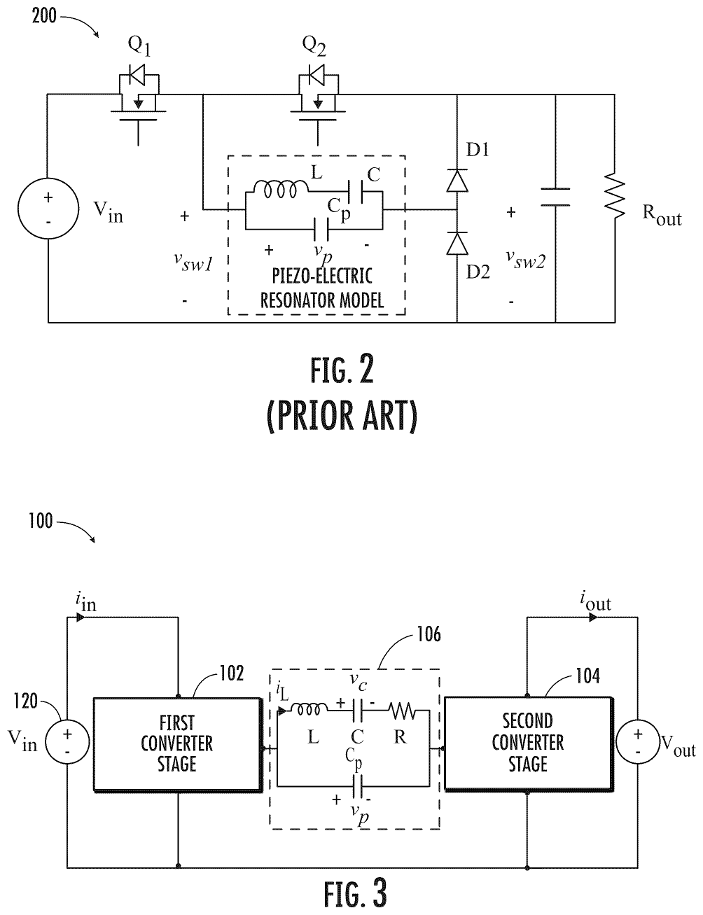

Unlike the baseline converter of FIG. 2 in which the piezoelectric resonator is directly exposed to the input and output voltages, the power converter 100 of FIG. 6 reduces the range of input voltages that the piezoelectric-resonator 106 is exposed to by utilizing the switched capacitor network of the first converter stage 102. That circuit typology decreases the amount of charge delivered to the piezoelectric-resonator 106 to change its voltage and achieves a relatively flat and high efficiency across a wide voltage conversion ratio range. The switched capacitor 110 and the piezoelectric-resonator 106 are merged together to soft-charge the switched-capacitor using the inductive current coming from the piezoelectric-resonator 106, which avoids otherwise excessive loss due to capacitor hard charging. It should be appreciated that by adding two switches and the flying capacitor (C_{fc}) 110 across the middle two switches, the voltage applied across the piezoelectric-resonator 106 (i.e., the difference between the two switch node voltages, v_{sw1} and v_{sw2}) is decreased. This results in a lower inductive branch current (i_{L}), which leads to a higher efficiency.

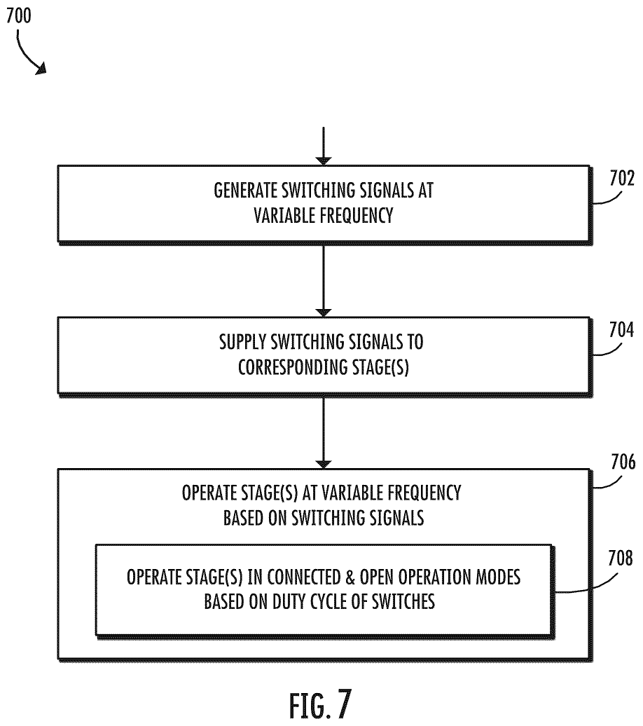

Referring now to FIG. 7, in use, the converter controller 108 may execute a method 700 for controlling operation of the power converter 100 (i.e., controlling the operation of the first and/or second converter stages 102, 104. The method 700 begins with block 702 in which the converter controller 108 generates a set of switching signals at a variable frequency. The converter controller 108 supplies those switching signals to the converter stages 102, 104 embodied as switched-capacitor networks in block 704. In block 706, the respective converter stage is operated at a variable frequency based on the switching signals received from the converter controller 108. For example, in the illustrative embodiment in block 708, the respective converter stage is operated in connected and open operation modes based on a defined duty cycle of the semiconductor switches of that converter stage and at a variable frequency.

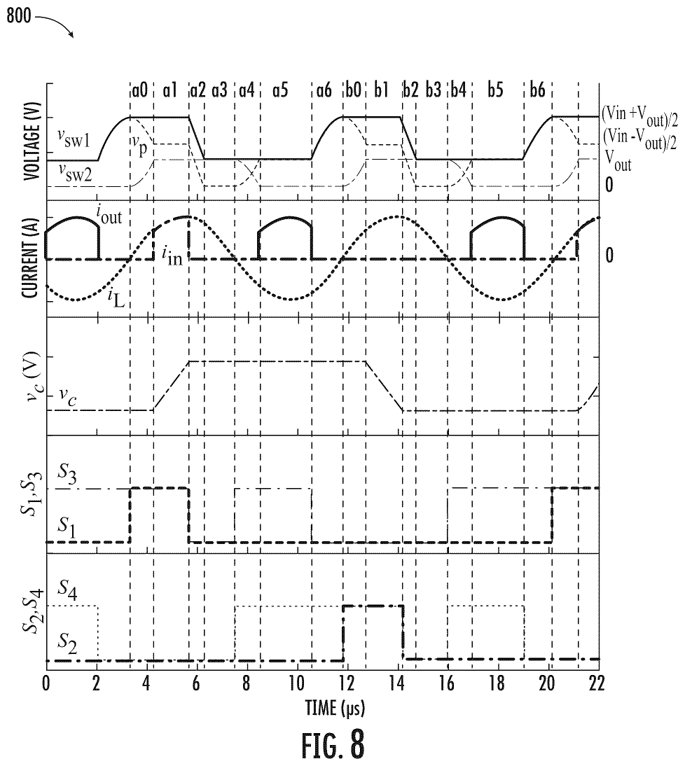

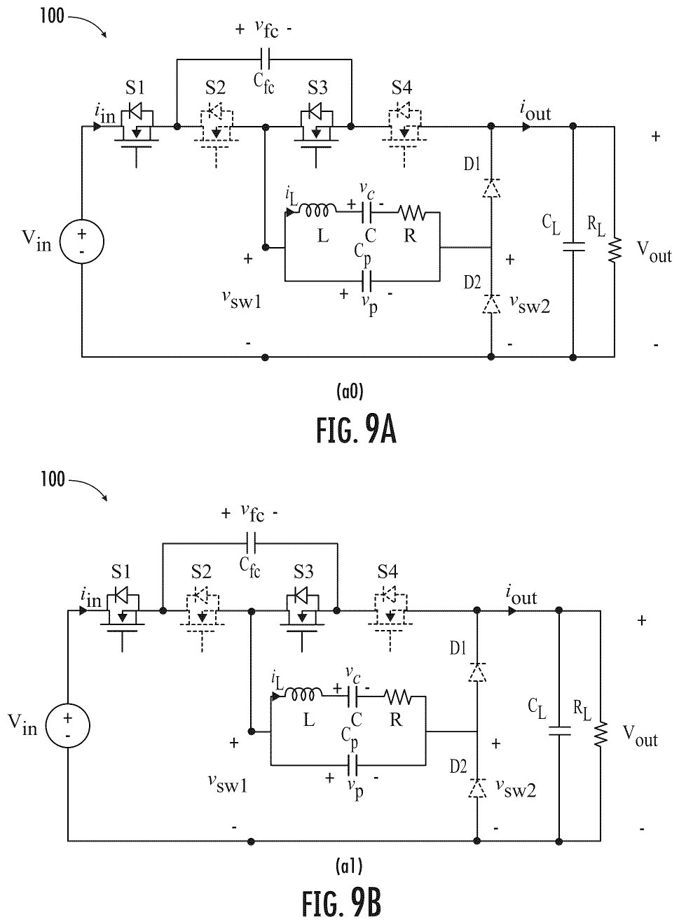

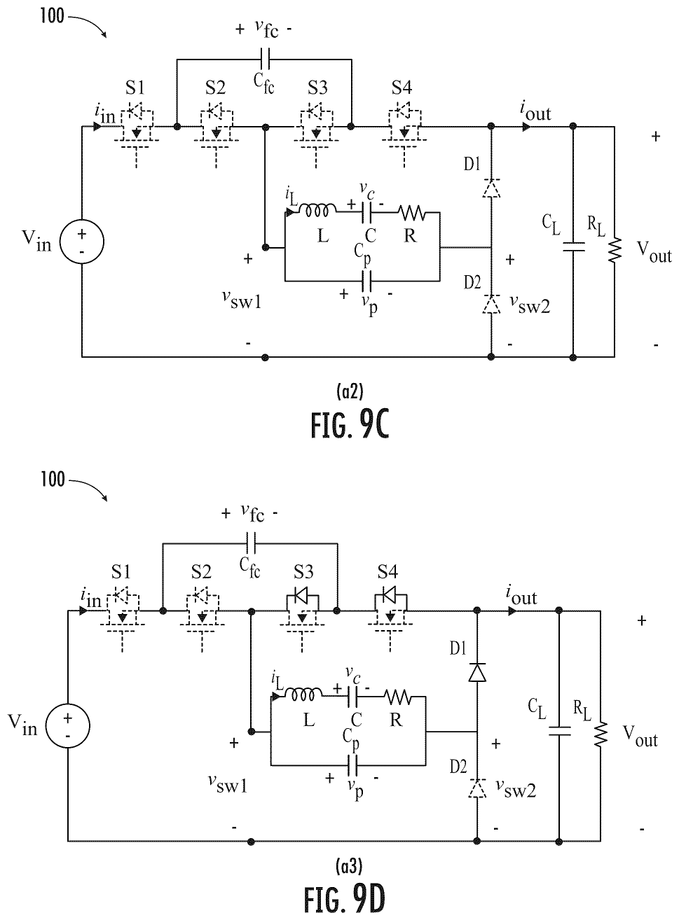

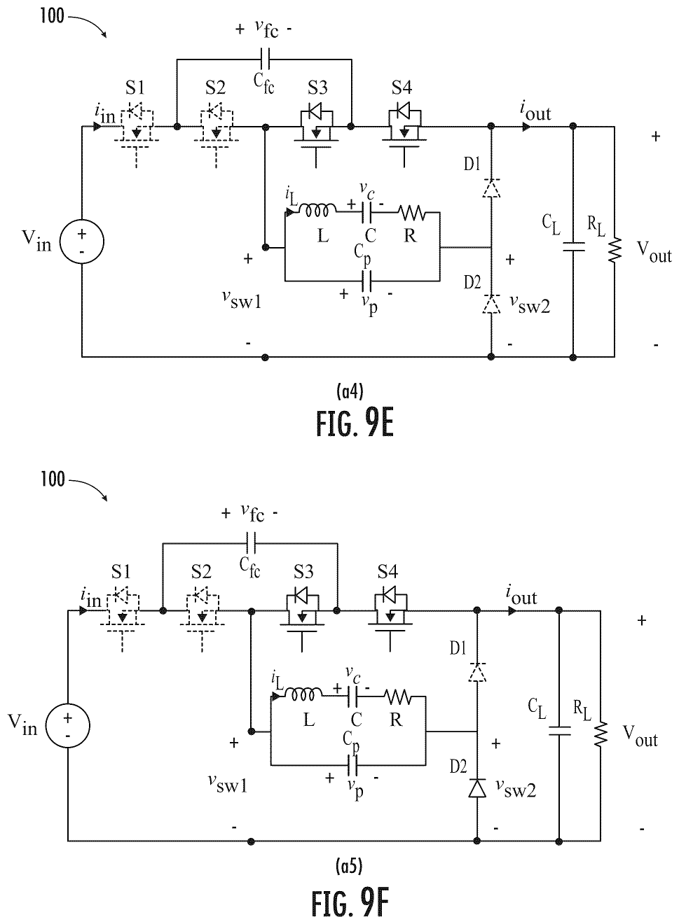

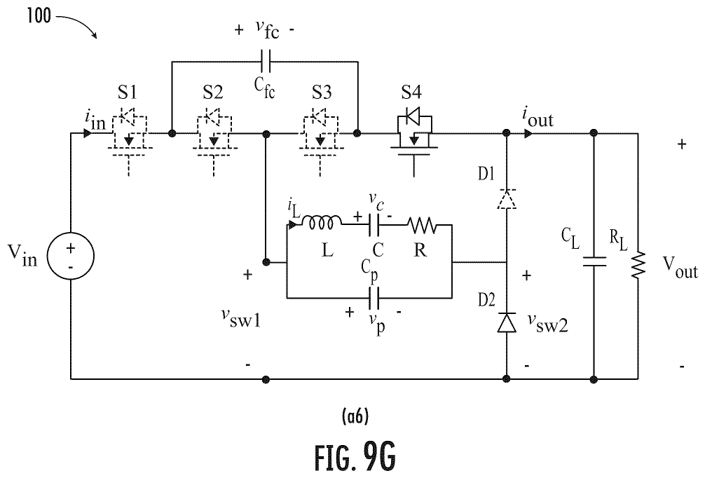

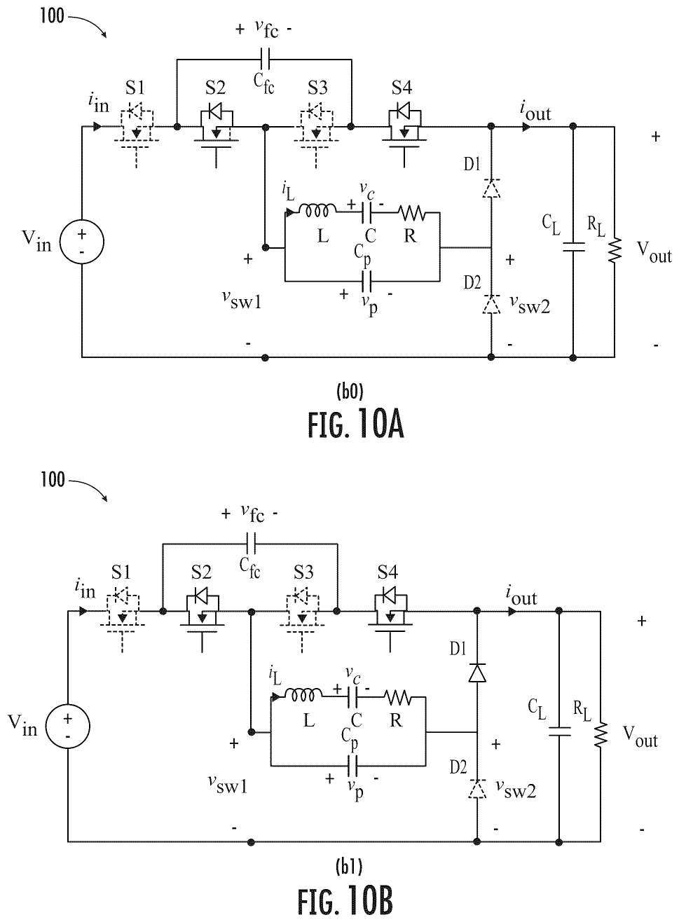

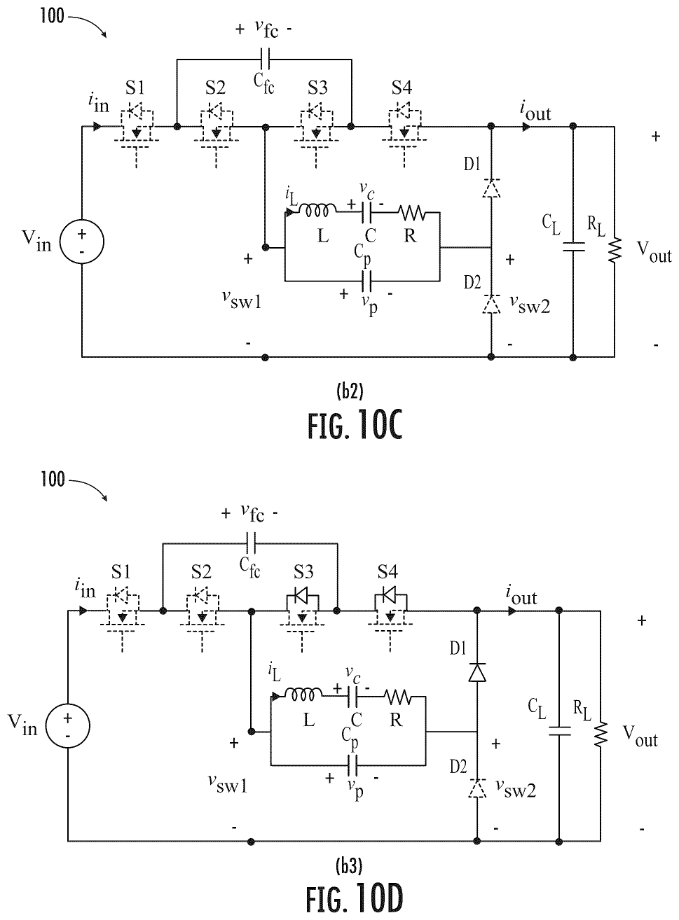

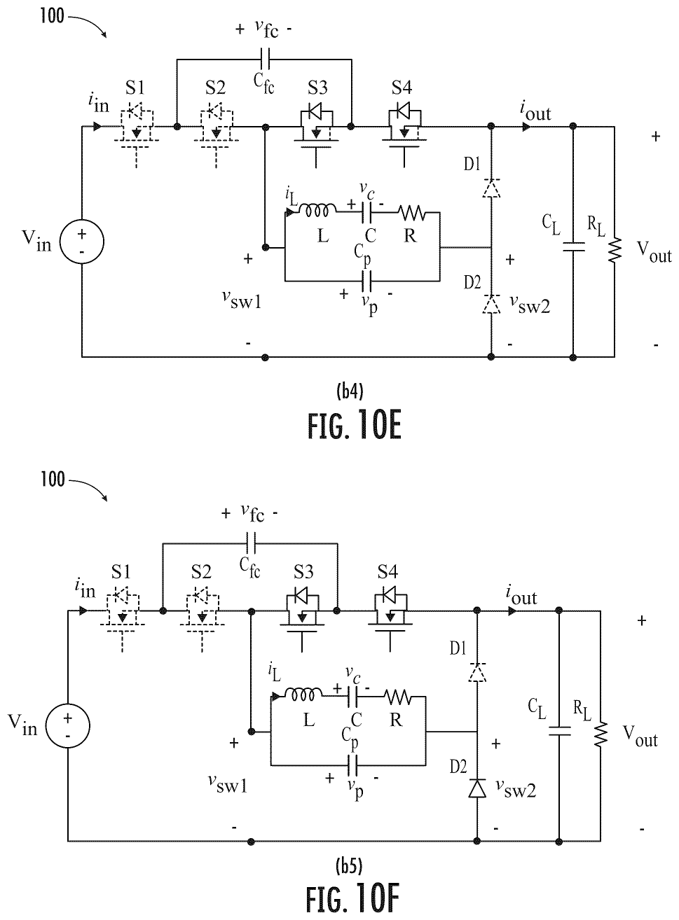

The operation of the power converter 100 is illustrated in FIG. 8 using steady-state waveforms and the associated circuit configurations for each of corresponding operating state is shown in FIGS. 9A-9G (charging cycle) and FIGS. 10A-10G (discharging cycle). The power converter 100 is modeled using its operating states, which includes connected states and open states as discussed above. The connected states correspond to circuit states in which both terminals of the piezoelectric-resonator 106 are connected to voltage sources, or effective voltage sources, such as Vᵢₙ, v_{fc} and Vₒᵤₜ, during which power is transferred to the piezoelectric-resonator 106 and to the load. The open states correspond to circuit states in which at least one terminal of the piezoelectric-resonator 106 is not connected to a voltage source. An open state is inserted between each connected state and is used to resonate the voltage across the piezoelectric-resonator 106 to a desired value determined by the voltage needed at the start of the next connected state so as to achieve zero voltage switching (ZVS) of the converter transistors. As shown in the example waveforms of FIG. 8, the proposed converter has a total of 14 states, including 6 connected states (a1, a3, a5, b1, b3, b5) corresponding to the circuit state shown in FIG. 9B (a1), FIG. 9D (a3), FIG. 9F (a5), FIG. 10B (b1), FIG. 10D (b3), and FIG. 10F, respectively; and 8 open states (a0, a2, a4, a6, b0, b2, b4, b6) corresponding to the circuit state shown in FIG. 9A (a0), FIG. 9C (a2), FIG. 9E (a4), FIG. 9G (a6), FIG. 10A (b0), FIG. 10C (b2), FIG. 10E (b4), and FIG. 10G (b6), respectively.

One consideration in the operation of the power converter 100 may be maintaining a desired stable voltage value across the flying capacitor 110. The desired average value of the flying capacitor 110 (C_{fc}) voltage is

$${v}_{fc} = \frac{{V}_{in} - {V}_{out}}{2} .$$

This can be achieved by charging and discharging the flying capacitor 110 in consecutive connected states. In the connected state a1 of the waveforms of FIG. 8, the flying capacitor 110 is charged by turning on S₁ and S₃ as shown in the circuit of FIG. 9B (a1), and in this state the switch node voltage

$${v}_{sw 1} = \frac{{V}_{in} + {V}_{out}}{2} .$$

To keep the flying-capacitor voltage relatively stable, C_{fc} is discharged in the next connected state b1, which is achieved by turning on S₂ and S₄ as shown in FIG. 10B (b1). In this state, the switch node voltage is also

$${v}_{sw 1} = \frac{{V}_{in} + {V}_{out}}{2} .$$

The steady-state waveforms of the power converter 100 can be determined by determining the state variables of the inductor-capacitor-resistor (LCR) branch of the piezoelectric-resonator 106 using time domain analysis. While the converter has fourteen states, as shown in FIG. 8, the state variables associated with the piezoelectric-resonator 106 repeat after seven states. The initial values of the piezoelectric resonator's LCR branch capacitor voltage v_{c} and its LCR branch inductor current i_{L} at the beginning of each of the seven states (i.e., a total of 14 unknowns) must satisfy conservation of charge (CoC) and conservation of energy (CoE). These constraints provide one equation per each of the three connected states (using CoE) and two equations per each of the four open states (using CoC and CoE), resulting in a total of eleven constraint equations. Two additional constraint equations can be derived by enforcing that switch S₁ is turned on when the LCR branch inductor current i_{L} goes through its negative-to-positive zero crossing to ensure that the converter's input current is always positive, and that switches S₃ and S₄ are turned on when the LCR branch inductor current i_{L} goes through its positive-to-negative zero crossing to ensure that the converter's output current is also always positive. The final constraint equation comes from equating the converter's average output power Pₒᵤₜ to the energy flowing from the piezoelectric resonator to the output port of the converter over its complete fourteen state cycle divided by the duration of this cycle.

The above described fourteen equations can be solved simultaneously for the 14 initial voltage and current values. These can then be used in conjunction with the circuits corresponding to each state of the power converter 100 to determine the periodic steady-state waveforms of the proposed converter.

Based on the steady-state waveforms, a charge transfer utilization factor K can be defined as the ratio of charge delivered to the output to the charge transferred to the piezoelectric-resonator 106. During the flying capacitor 110 charging cycle (cycle a), charge is delivered to the load in states a1 and a5, and during the flying capacitor 110 discharging cycle (cycle b), charge is delivered to the load only in state b5, as shown in FIG. 8. K can be derived as:

$$K = \frac{\vert {q}_{1} \vert + 2 \vert {q}_{5} \vert}{2 ( \vert {q}_{1} \vert + \vert {q}_{3} \vert + \vert {q}_{5} \vert )} .$$

Based on conservation of charge (CoC), the charge delivered in one cycle to C and Cₚ should be zero, thus

$$K = \frac{{V}_{in}}{2 ( {V}_{in} - {V}_{out} )} .$$

The utilization factor of the proposed converter is the same as in the baseline converter. The amplitude of the circulating current of the piezoelectric-resonator 106 (I_{L}) is derived as

$${I}_{L} = \frac{π}{2} {fQ}_{total} = π ( \frac{{P}_{out}}{2 {KV}_{out}} + {fC}_{p} {V}_{pp} ) .$$

The Vₚₚ is the full voltage swing across the piezoelectric-resonator 106. For the baseline converter Vₚₚ=Vᵢₙ, while the proposed converter has

$${V}_{pp} = \frac{{V}_{in} + {V}_{out}}{2} .$$

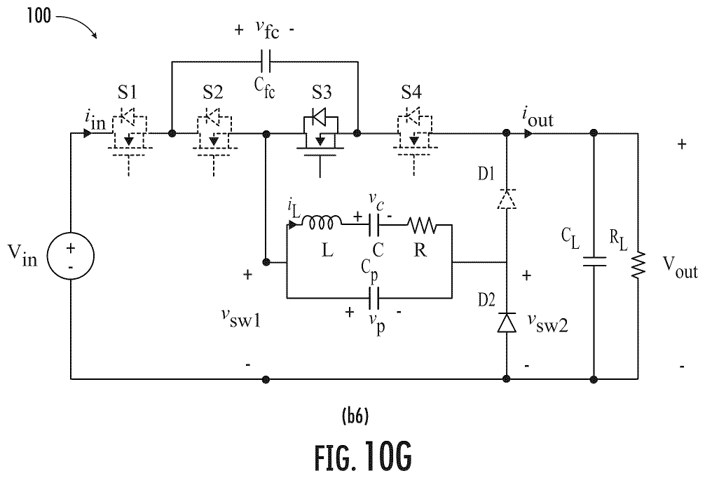

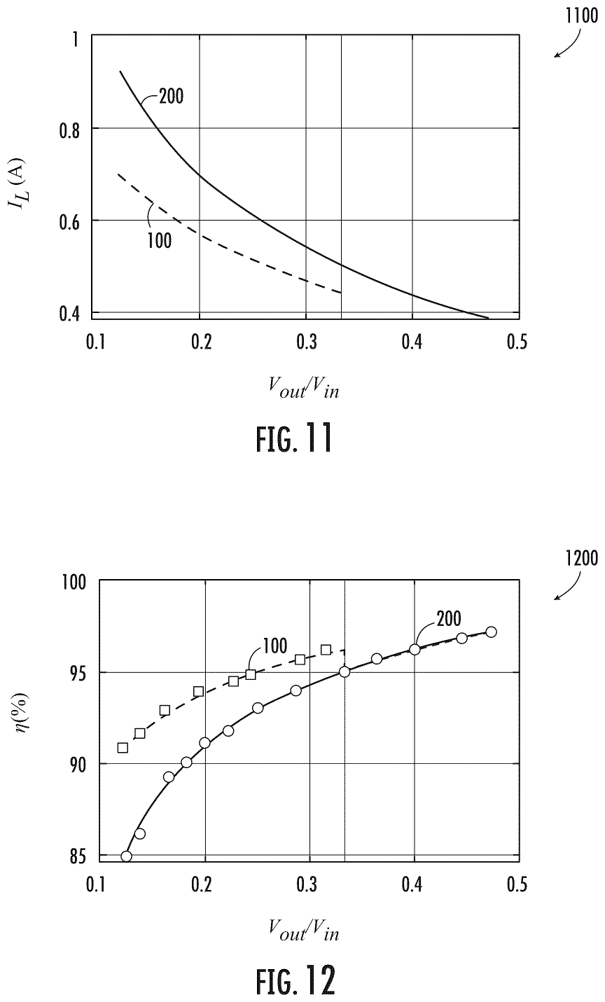

Thus, the predicted amplitude of the current in the proposed converter is smaller than the estimated current amplitude in the baseline converter 200 given the same conversion ratio, as shown in graph 1100 of FIG. 11.

The efficiency of the converter (η) can be calculated considering the energy loss of the piezoelectric-resonator 106 (Eₗₒₛₛ),

$${E}_{loss} \approx {\int }_{0}^{\frac{1}{f}} {{i}_{L} ( t )}^{2} Rdt = {\int }_{0}^{\frac{1}{f}} {( {I}_{L} sin ( 2 π ft ) )}^{2} Rdt = \frac{1}{2 f} {I}_{L}^{2} R \qquad ( 1 )$$

$$η \approx \frac{{P}_{out}}{{P}_{out} + {fE}_{loss}} = \frac{{P}_{out}}{{P}_{out} + \frac{1}{2} {I}_{L}^{2} R} \qquad ( 2 )$$

Given the same piezoelectric-resonator 106, the power converter 100 is able to achieve the same conversion ratio with a smaller I_{L} compared to the baseline converter 200. The efficiency of the power converter 100 will be higher, and the efficiency difference becomes larger as the conversion ratio becomes extreme, as shown in graph 1200 of FIG. 12. The voltage conversion ratio of the power converter 100 has an upper limit of about one-third; however, by controlling the c three-level switched-capacitor network of the power converter 100 in a manner such that the power converter 100 acts like the two-level baseline converter 200 allows the power converter 100 to achieve higher conversion ratios. The control of the baseline converter 200 together with the control methodology illustrated in FIGS. 7 and 8 can be combined to form a hybrid control to achieve wide voltage conversion. The expected efficiency using the hybrid control is the same as the baseline when Vₒᵤₜ/Vᵢₙ is greater than one-third, while the proposed converter has higher efficiency when Vₒᵤₜ/Vᵢₙ is less than one-third.

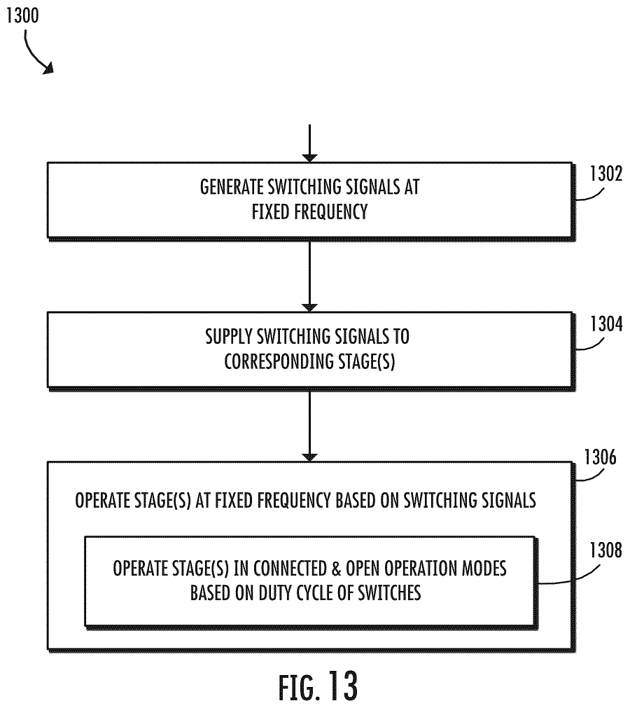

Referring now to FIG. 13, in other embodiments, the converter controller 108 of the power converter 100 may use a fixed frequency to control the converter stages 102, 104 of the power converter 100. In such embodiments, the converter controller 108 may execute a method 1300. The method 1300 begins with block 1302 in which the converter controller 108 generates a set of switching signals at a fixed frequency. The converter controller 108 supplies those switching signals to those converter stages 102, 104 embodied as switched-capacitor networks in block 1304. In block 1306, the respective converter stage is operated at the fixed frequency based on the switching signals received from the converter controller 108. For example, in the illustrative embodiment in block 1308, the respective converter stage is operated in connected and open operation modes based on a defined duty cycle of the semiconductor switches of that converter stage and at a fixed frequency.

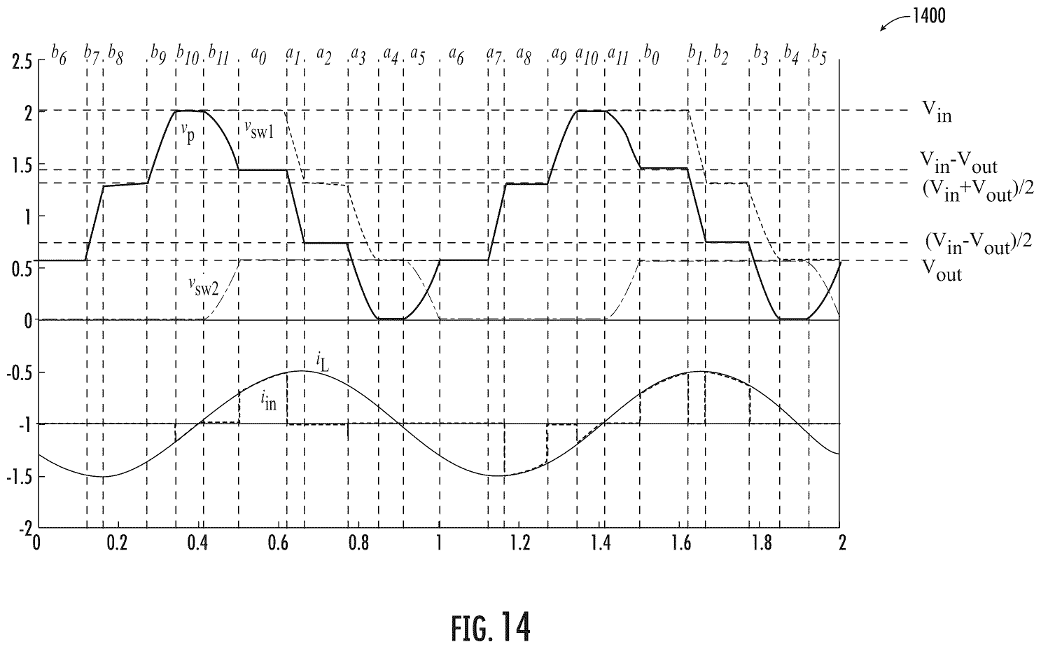

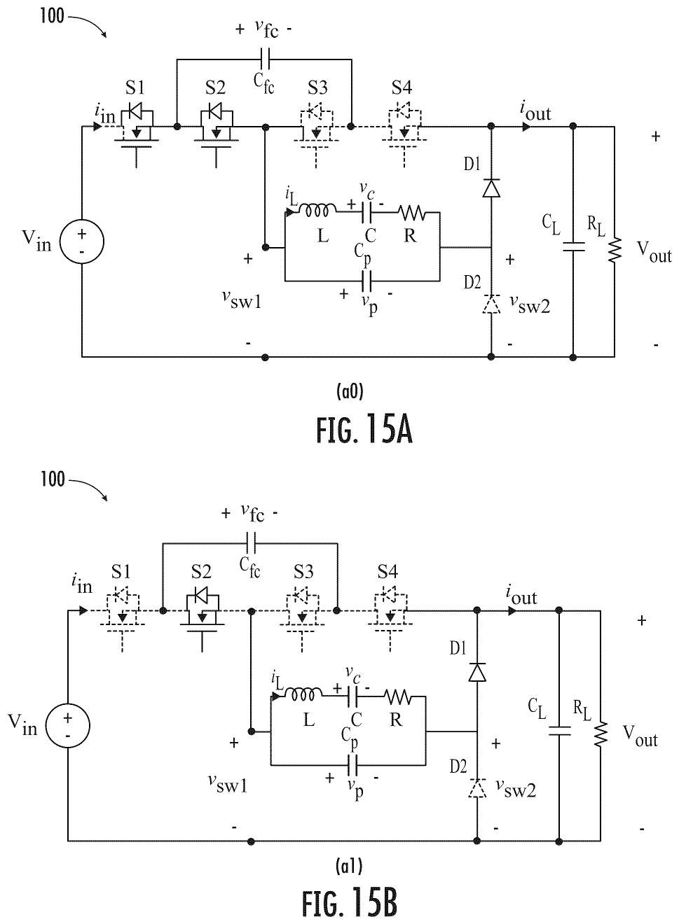

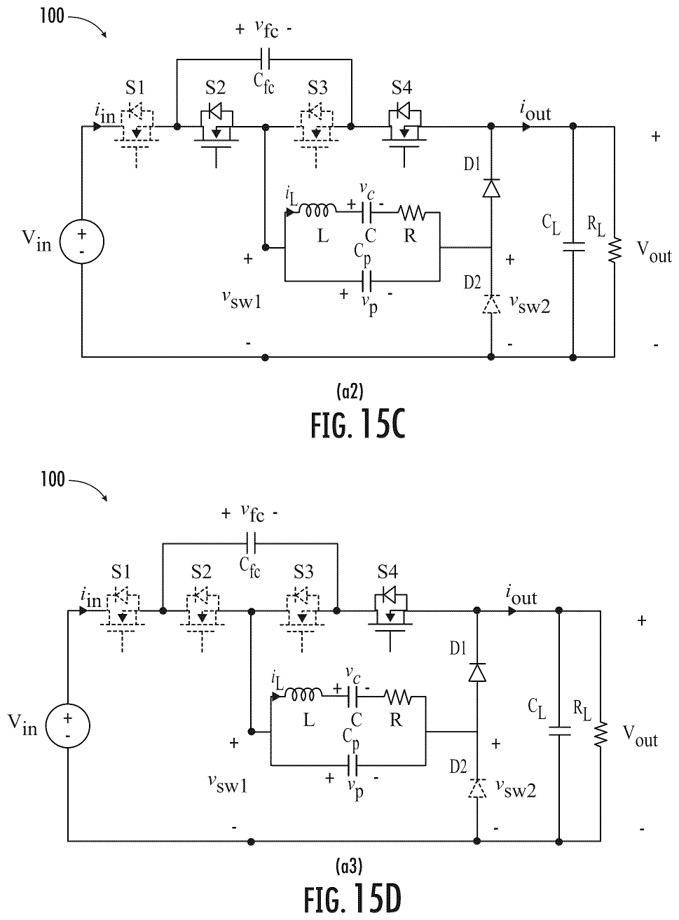

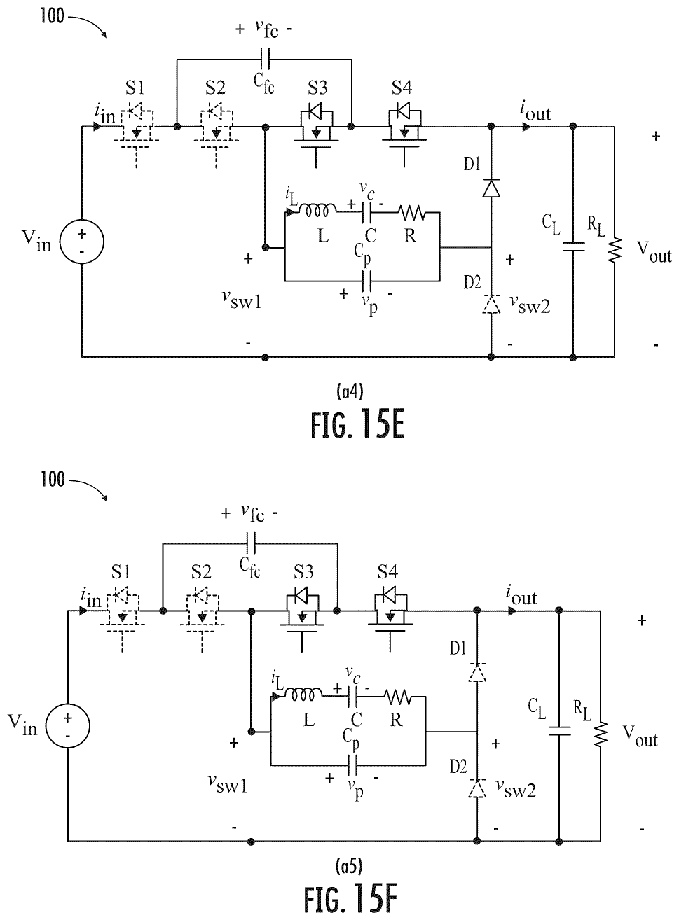

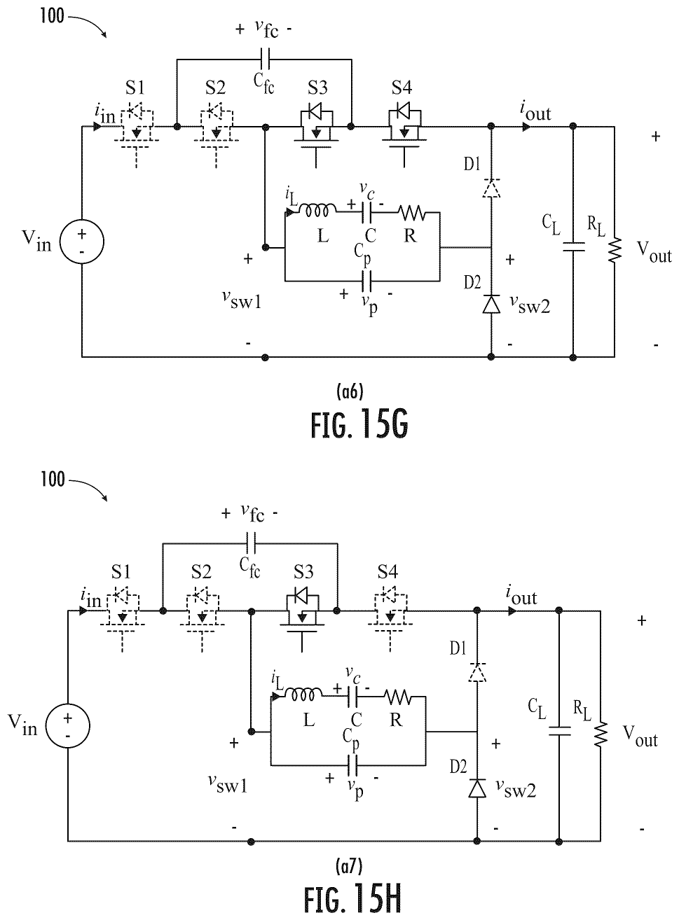

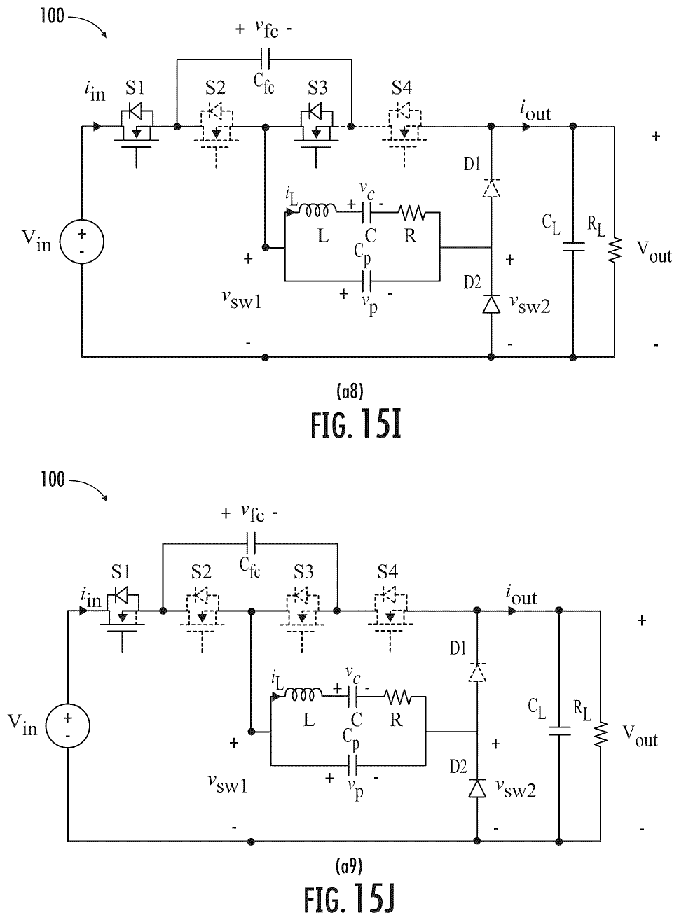

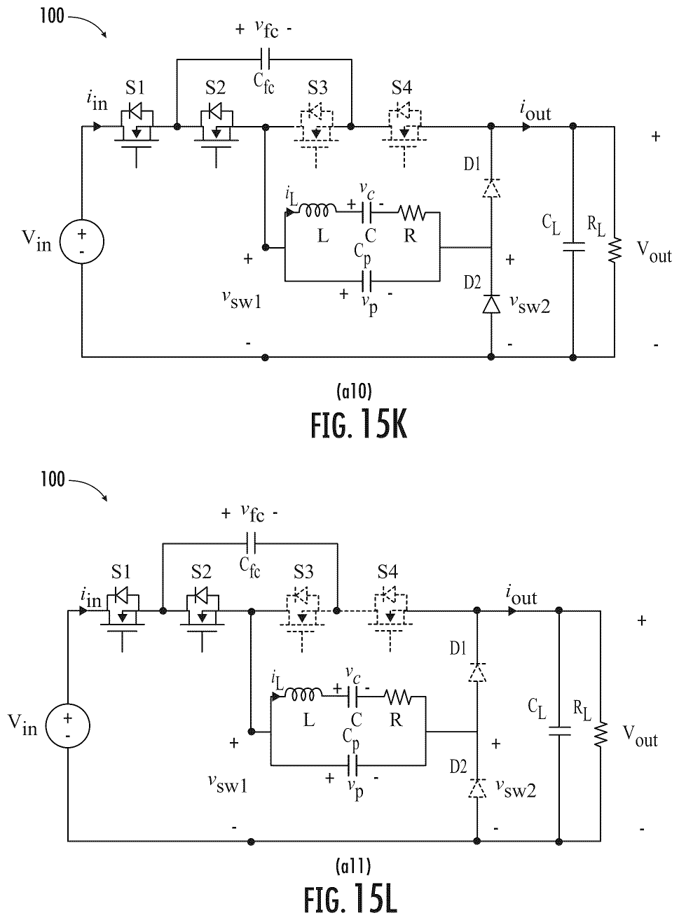

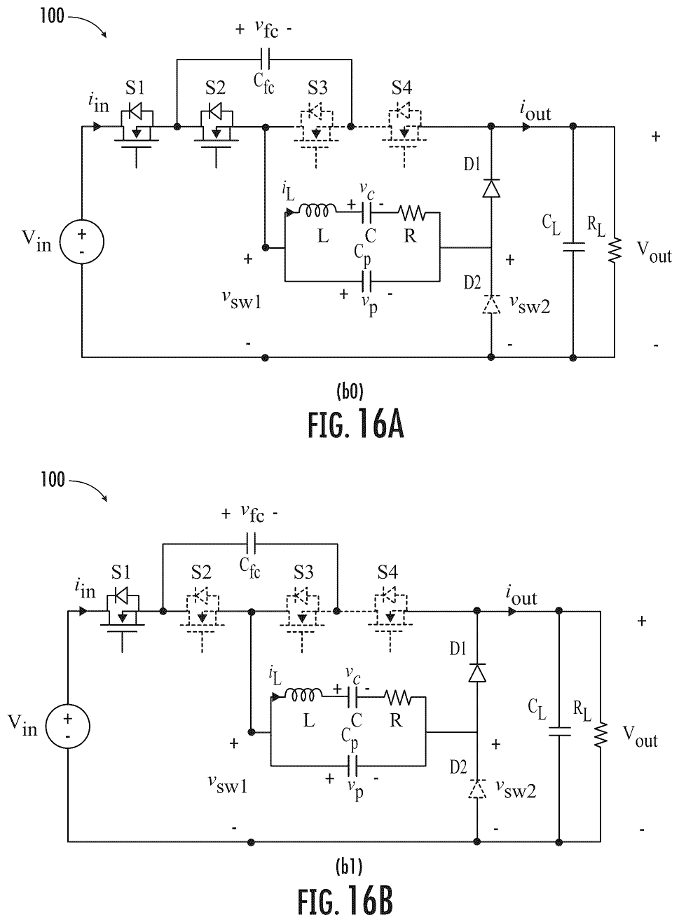

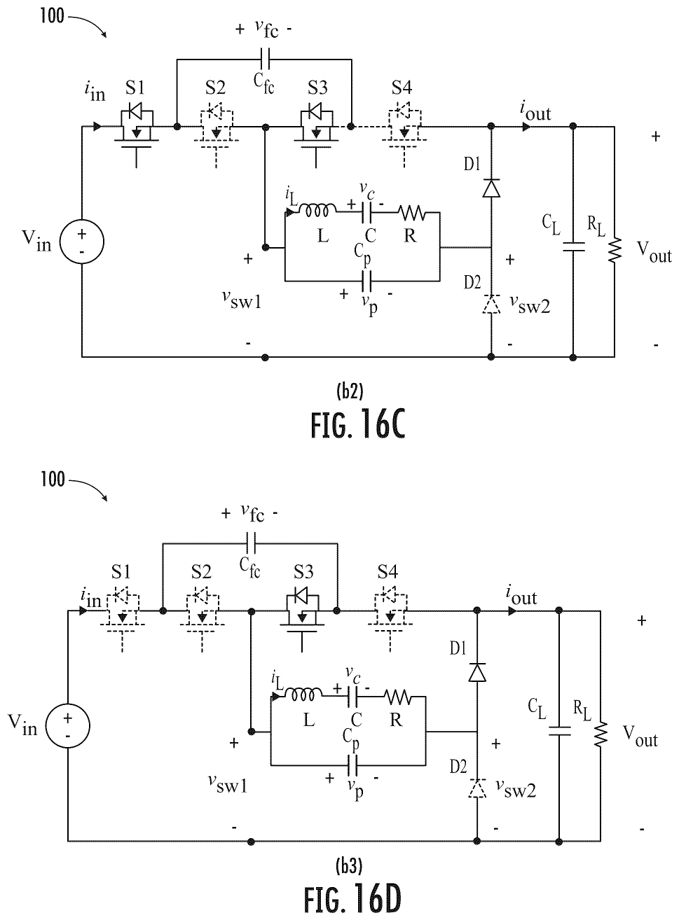

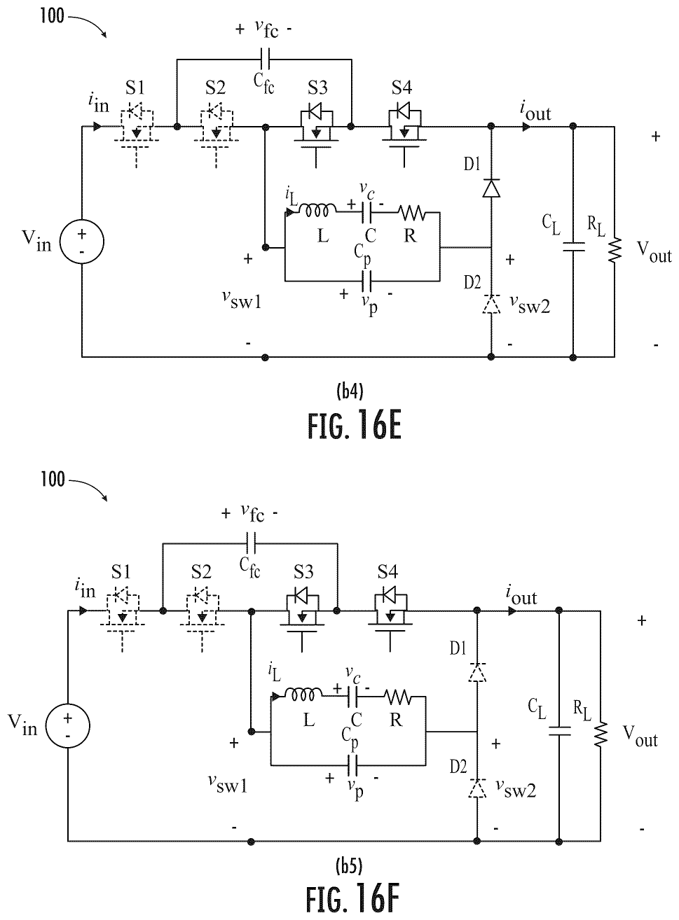

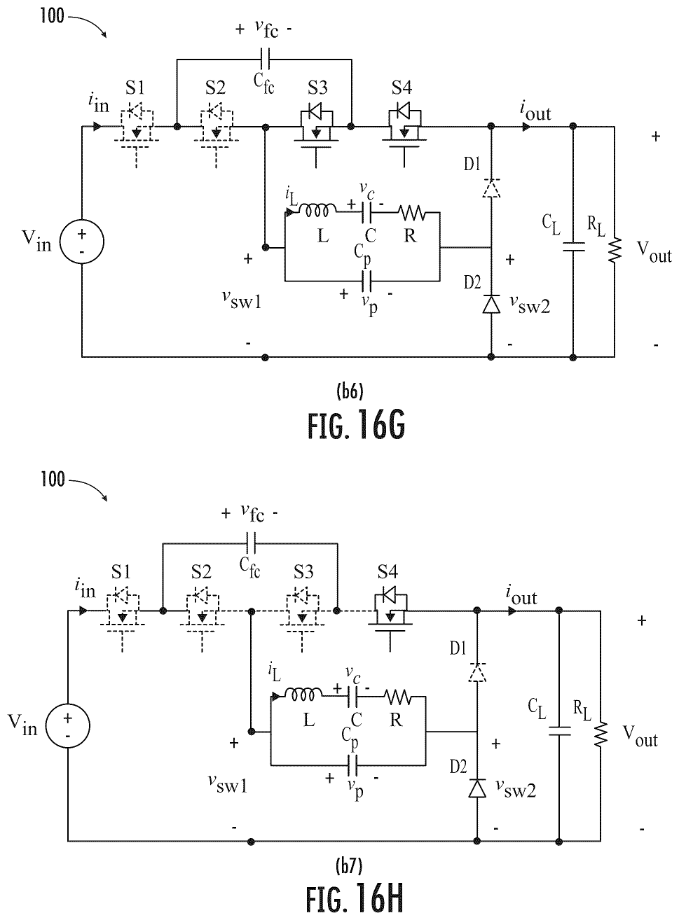

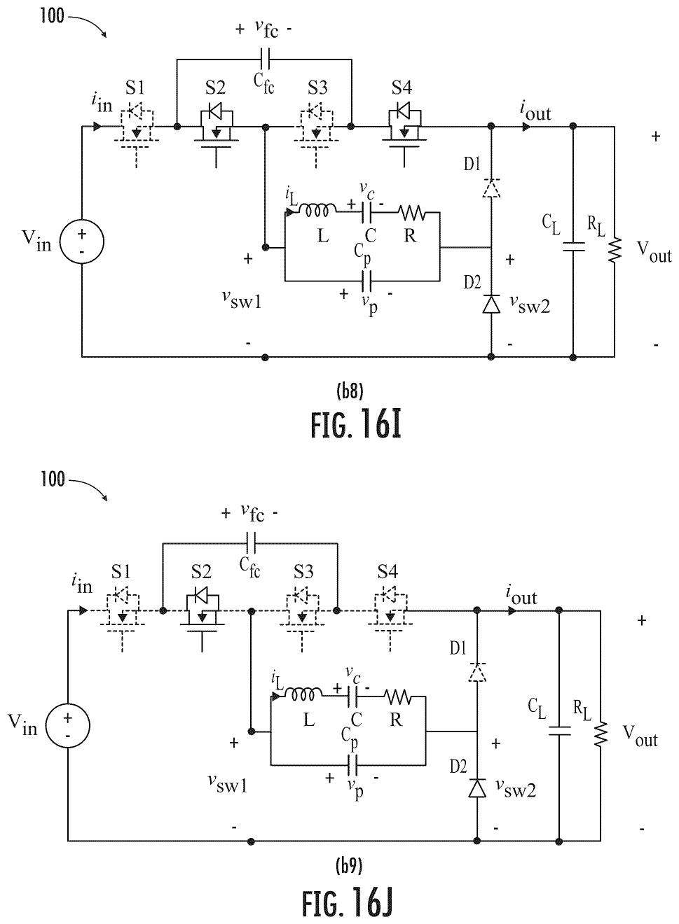

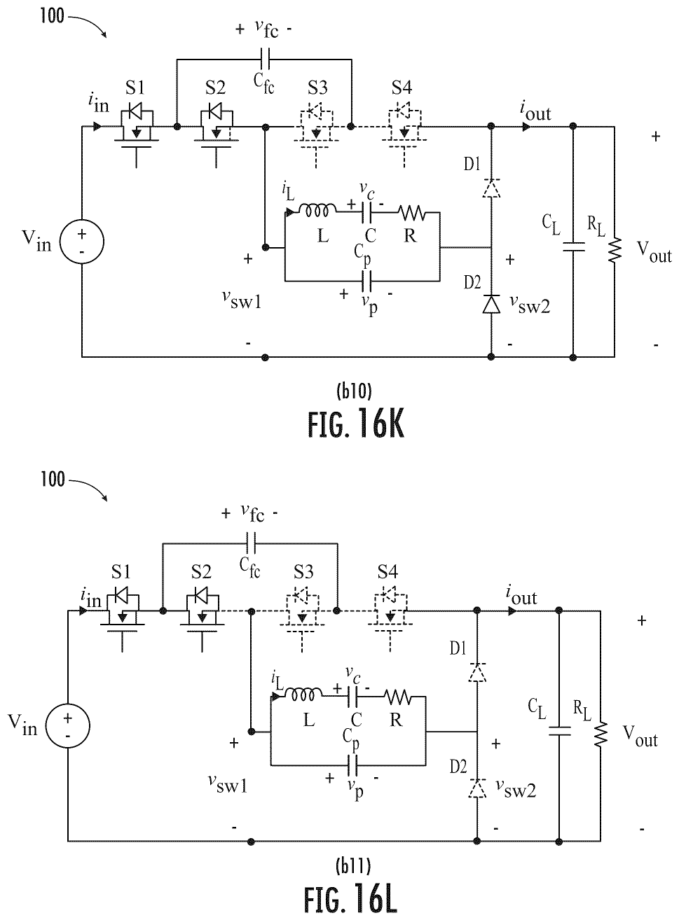

The operation of the power converter 100 using the fixed frequency control methodology of FIG. 13 is illustrated in FIG. 14 using steady-state waveforms and the associated circuit configurations for each of corresponding operating state is shown in FIGS. 15A-15L (charging cycle) and FIGS. 16A-16L (discharging cycle). The control methodology of FIG. 13 achieves power modulation by having additional states, relative to the waveform of FIG. 8, in which the flying capacitor 110 is bypassed. Those additional states enable the power converter 100 to have power modulation at a constant frequency. It should be appreciated that the control methodology of FIGS. 13 and 14 define an interpolation between the topology of the baseline converter topology 200 and the power converter 100 with the control methodology of FIGS. 7 and 8. Using the control methodology of FIGS. 13 and 14, the power converter 100 can have power modulation under fixed frequency. Soft charging of the switched capacitor 110, the body capacitance of the piezoelectric-resonator 106 along with all switches can be achieved.

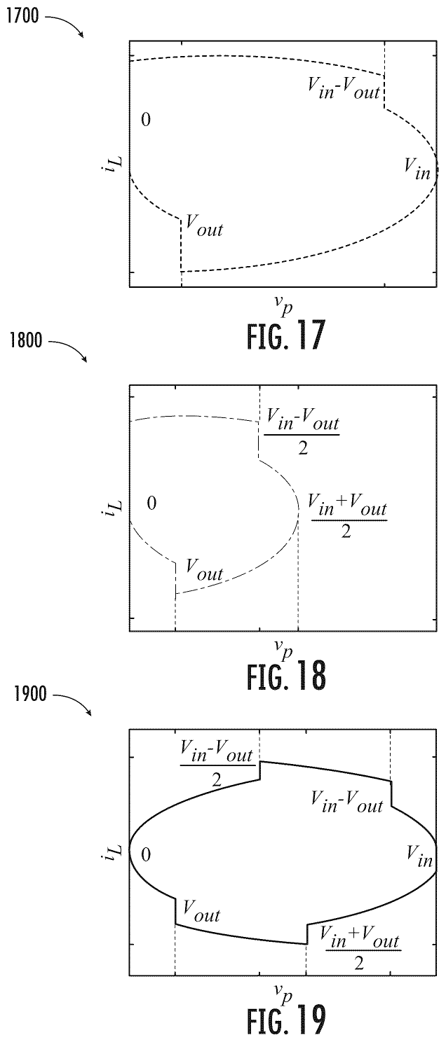

It should be appreciated that the switched capacitor 110 enables the power converter 100 to have connected states with multiple values of different equivalent connected voltage source. For example, as shown in the steady-state waveforms in FIG. 14 and the state plane diagrams of FIGS. 17-19, the connected states can have six voltage levels of

$${V}_{in} , {V}_{in} - {V}_{out} , \frac{{V}_{in} - {V}_{out}}{2} , \frac{{V}_{in} + {V}_{out}}{2} , {V}_{out} , 0.$$

Those six connected states can be compared with a state plane diagram for the baseline converter 200 having four voltage levels of Vᵢₙ, Vᵢₙ−Vₒᵤₜ, Vₒᵤₜ, 0 and to a state plane diagram of the power converter 100 using the control methodology described above in regard to FIGS. 7 and 8 having four voltage levels of

$$\frac{{V}_{in} + {V}_{out}}{2} , \frac{{V}_{in} - {V}_{out}}{2} , {V}_{out} , 0.$$

The fixed frequency voltage modulation capability of the control methodology of FIGS. 7 and 8 can be achieved by regulating the time during which the switched capacitor 110 is connected to the piezoelectric-resonator 106. Under a certain frequency, the range of such voltage modulation can be found in between the baseline converter 200 and the power converter 100 with the described operation modes. The control signal for each of the switches can be generated by solving a set of steady-state conservation equations. Moreover, if the dead-times are controlled properly the states which short the piezoelectric-resonator 106 capacitance or push current back to the voltage source can be nullified and hence the power converter 100 could be controlled by only using four states. Such a control methodology may increase efficiency by decreasing the circulating current.

In the fixed frequency operation mode, voltage balancing across the flying capacitor 110 is established by the charging cycle of FIGS. 15A-15L and the discharging cycles of FIGS. 16A-16L. The associated state plane is identical in both the charging and discharging cycles.

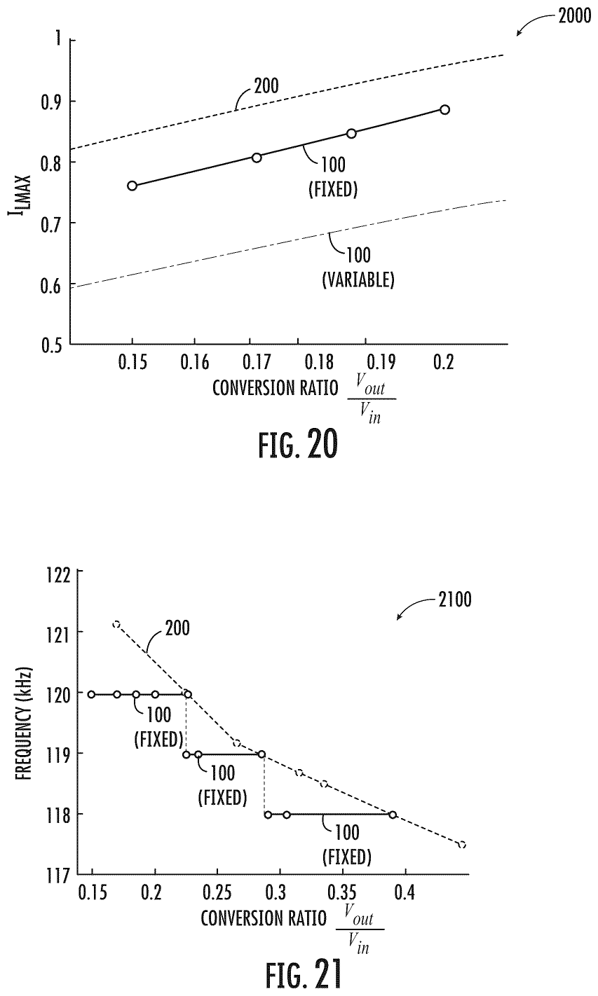

The steady-state performance of the power converter 100 using the fixed frequency control methodology of FIGS. 13 and 14 may be compared with the baseline converter 200 (having the state plane 1700 of FIG. 17) and the power converter 100 using the variable frequency control methodology of FIGS. 7 and 8 (having the state plane 1800 of FIG. 18). The estimated inductive motion branch current I_{Lmax} using simulation is compared with the baseline converter 200, as shown in graph 2000 of FIG. 20. When operating the power converter 100 with the fixed frequency control methodology, the input voltage and the load resistance are fixed, while the output voltage is modulated by having different on-time and dead time while having a fixed frequency. Conversely, the baseline converter 200 and the power converter 100 operated with a variable frequency control methodology modulates the output voltage but with a variable frequency. The power converter 100 using the fixed frequency control methodology may achieve a lower inductive motion branch current than the baseline converter 200, which leads to a higher efficiency.

As shown in graph 2100 of FIG. 21, the input voltage is fixed while the output voltage is changed based on the on-time and dead time of each switch. Compared with the baseline converter 200 operation mode, the power converter 100 operated with a fixed frequency control methodology achieves fixed frequency voltage modulation. For one fixed frequency, the achievable range of voltage modulation of the proposed operation mode can also be seen, which is between the operation mode of the baseline converter 200 and the power converter 100 operated with a variable frequency control methodology. For example, at fixed frequency at 120 kHz, the power converter 100 operated with a fixed frequency control methodology has voltage modulation in the range from 0.15 to 0.22. At the higher end of that range, the power converter 100 operated with a fixed frequency control methodology nears the baseline converter 200 operation mode illustrated in the state plane 1700 of FIG. 17.

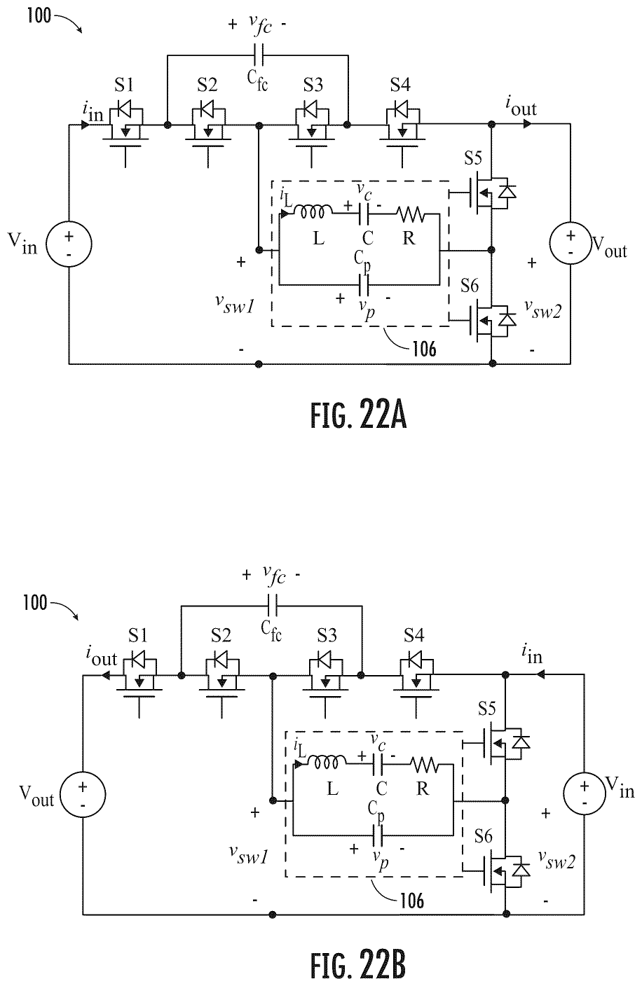

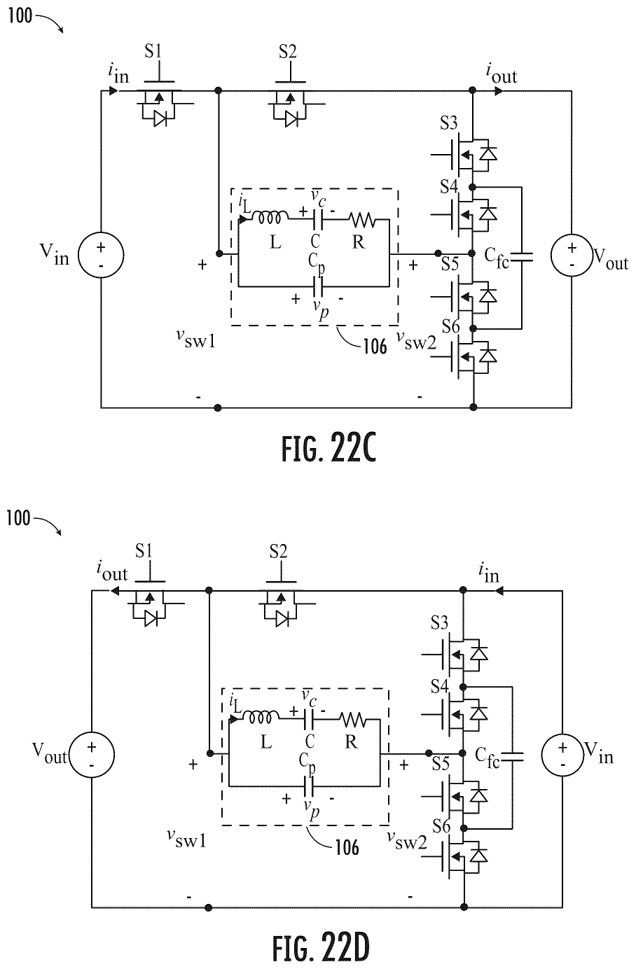

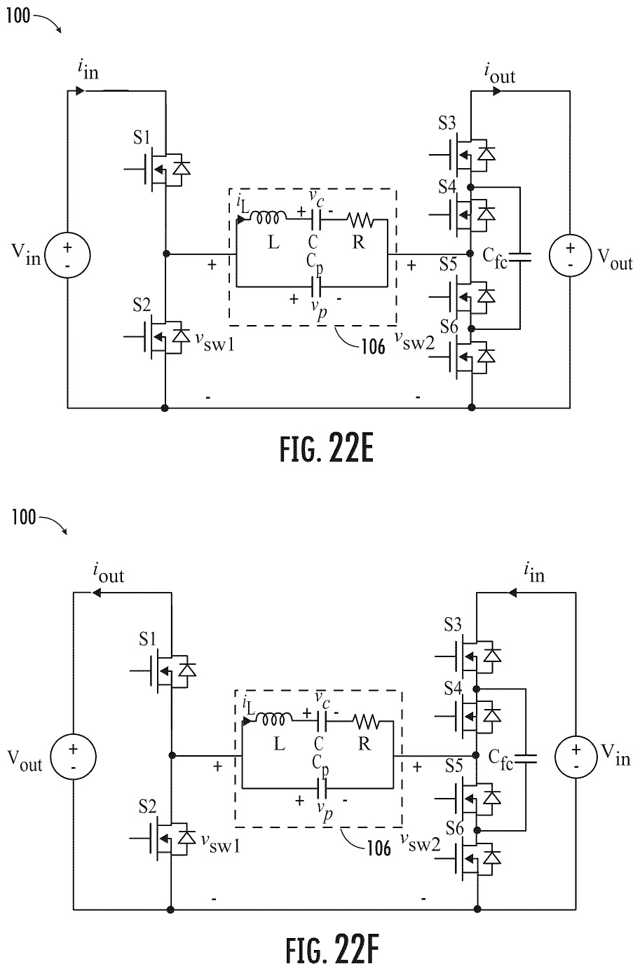

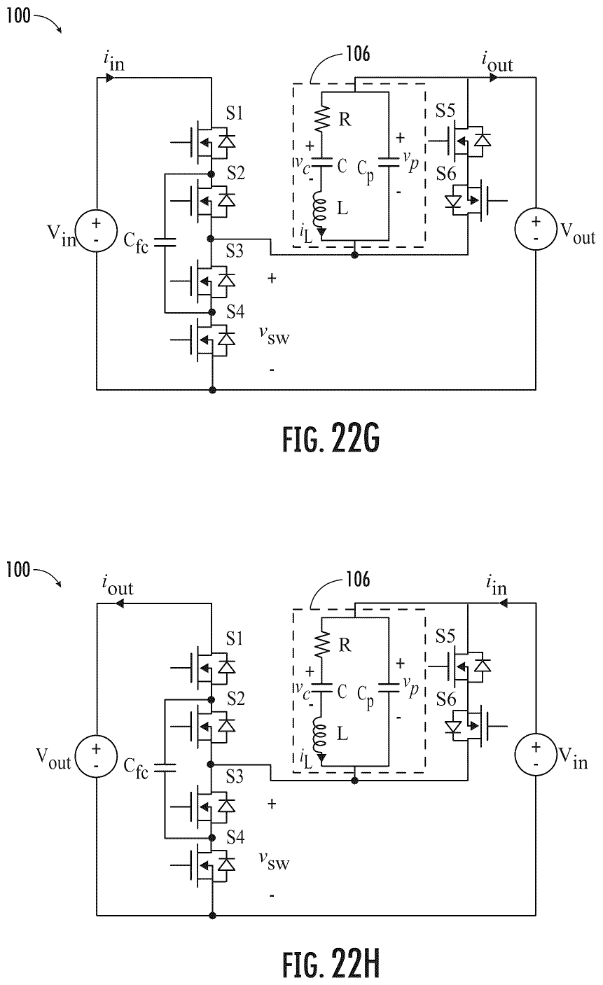

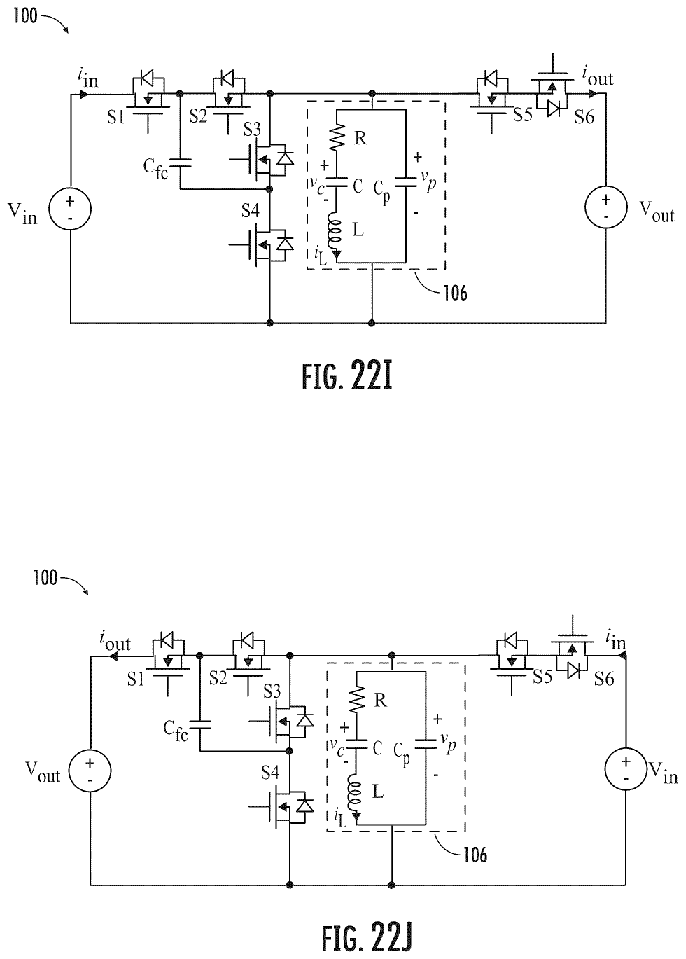

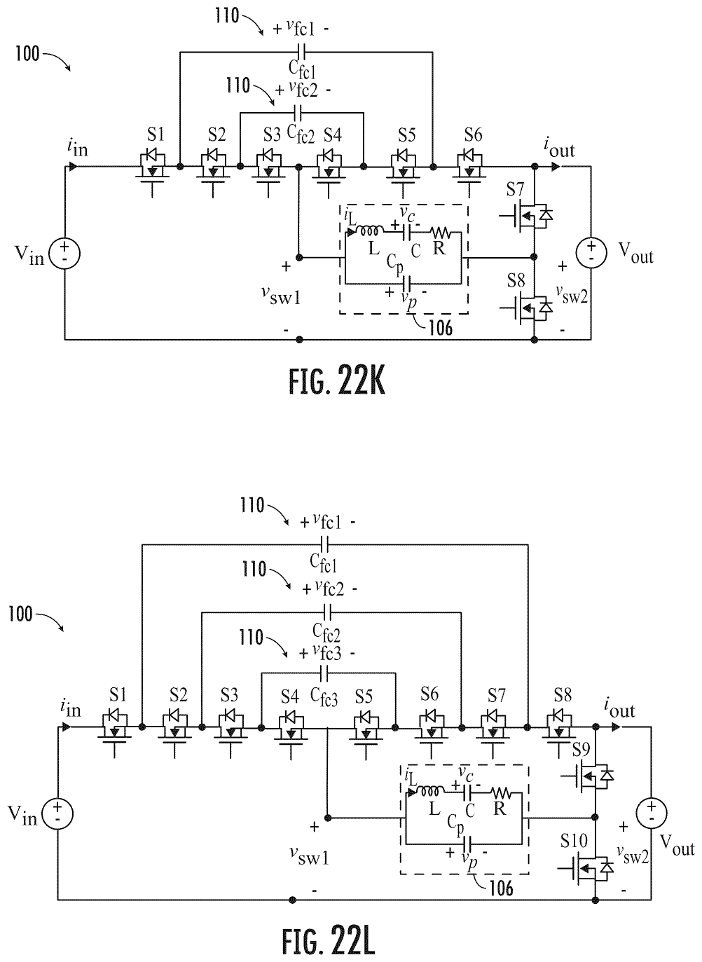

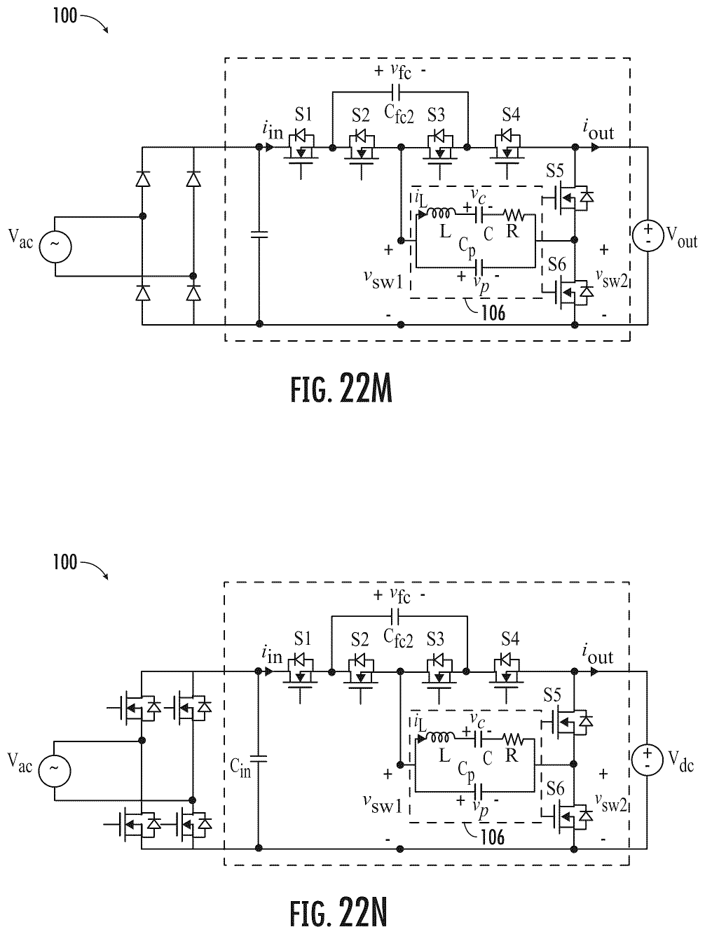

It should be appreciated that the various embodiments of the power converter 100 described thus far are only a sample of the circuit topology of the disclosed merged switched-capacitor piezoelectric-resonator based power converter. For example, it should be appreciated that the embodiment of the power converter 100 shown in FIG. 6 is unidirectional, i.e., power only flows from its input port to its output port. However, by replacing the two diodes of the second converter stage 104 of the power converter 100 of FIG. 6 with two transistors, or other controllable switches with bidirectional current carrying capability, the power converter 100 can be converted into a bidirectional converter, i.e., power can flow from its input port to its output port or vice versa. An embodiment of such a merged switched-capacitor piezoelectric-resonator based bidirectional dc-dc converter is shown in FIG. 22A. An alternative of the power converter 100 of FIG. 22A is shown in FIG. 22B in which the input and output ports have been swapped.

It should also be appreciated that additional embodiments of the described merged switched-capacitor piezoelectric-resonator based unidirectional and bidirectional DC-DC converters can be formed by modifying how the switched-capacitor network, the piezoelectric-resonator, and the remaining switches (or diodes) are connected with each other and the input and output ports. For example, various additional embodiments, configured to be bidirectional, are shown in FIG. 22C-22J. It should be further appreciated that unidirectional versions of the embodiments of FIGS. 22C-22J can also be formed by replacing some of the transistors with diodes.

Additionally, it should be appreciated that because the power converter 100 illustrated in FIGS. 22A-22J are bidirectional, those embodiments can used to provide a buck (voltage step-down) function or a boost (voltage step-up) function by swapping the source and the load. For example, the power converters 100 of FIG. 22A and FIG. 22B are identical except that the input and output have been swapped. Similarly, the power converters 100 of FIG. 22C and FIG. 22D, FIG. 22E and FIG. 22F, FIG. 22G and FIG. 22H, and FIG. 22I and FIG. 22J are identical except that the input and output have been swapped.

It should further be appreciated that the unidirectional and bidirectional power converters 100 described thus far utilized a switched-capacitor network with a single flying capacitor. Higher order variants of the disclosed merged switched-capacitor piezoelectric-resonator based unidirectional and bidirectional DC-DC converters 100 can also be formed that utilize switched-capacitor networks with a larger number of switches 112 and flying capacitors 110. Those higher-order merged switched-capacitor piezoelectric-resonator based DC-DC converters 100 have switched-capacitor networks that provide more levels, which can further improve the efficiency of the power converter 100 at higher conversion ratios. Two illustrative variants of these higher-order merged switched-capacitor piezoelectric-resonator based DC-DC converters 100 are shown in FIGS. 22K and 22L. The illustrative embodiment of FIG. 22K illustrates a merged switched-capacitor piezoelectric-resonator based DC-DC converter 100 having two flying capacitors 110, the illustrative embodiment of FIG. 22L illustrates a merged switched-capacitor piezoelectric-resonator based DC-DC converter 100 having three flying capacitors 110. It should be appreciated that by adding additional switches 112 and flying capacitors 110, even higher-order merged switched-capacitor piezoelectric-resonator based DC-DC converters 100 can be created.

It should additionally be appreciated that the merged switched-capacitor piezoelectric-resonator based DC-DC converters 100 described thus far can also be converted into AC-DC or DC-AC converters. For example, a merged switched-capacitor piezoelectric-resonator based AC-DC converter 100 is shown in FIG. 22M. The diode bridge converts AC line voltage into a rectified voltage. The rectified voltage is converted to a fixed DC voltage by a merged switched-capacitor piezoelectric-resonator based DC-DC converter. It should be appreciated that the embodiment of the merged switched-capacitor piezoelectric-resonator based DC-DC converter used in FIG. 22M is illustratively the embodiment of FIG. 11A; however, any of the other merged switched-capacitor piezoelectric-resonator based DC-DC converters discussed above can also be utilized. Additionally, a merged switched-capacitor piezoelectric-resonator based bidirectional AC-DC converter 100 is shown in FIG. 22N (i.e., it can also function as an AC-DC converter). The embodiment of FIG. 22N is formed by replacing the diode bridge in the converter of FIG. 22M with active switches.

Various embodiments of a merged switched-capacitor piezoelectric resonator-based dc-dc converter have been disclosed with each having relatively high efficiency across a wide conversion ratio. As discussed above, the described switched capacitor 110 and piezoelectric-resonator 106 are combined to form a multi-level structure, wherein the switched capacitor 110 is soft-charged by the current from the piezoelectric-resonator 106.

While the disclosure has been illustrated and described in detail in the drawings and foregoing description, such an illustration and description is to be considered as illustrative and not restrictive in character, it being understood that only illustrative embodiments have been shown and described and that all changes and modifications that come within the spirit of the disclosure are desired to be protected.

There are a plurality of advantages of the present disclosure arising from the various features of the methods, apparatuses, and systems described herein. It will be noted that alternative embodiments of the methods, apparatuses, and systems of the present disclosure may not include all of the features described yet still benefit from at least some of the advantages of such features. Those of ordinary skill in the art may readily devise their own implementations of the methods, apparatuses, and systems that incorporate one or more of the features of the present invention and fall within the spirit and scope of the present disclosure as defined by the appended claims.

1. A power converter comprising:
a first stage having a first terminal electrically connected to an input of the power converter and a second terminal electrically connected to a first output of the power converter;
a second stage having a first terminal electrically connected to the first output of the power converter and a second terminal electrically connected to a second output of the power converter; and
a piezoelectric-resonator having a first terminal electrically connected to a third terminal of the first stage and a second terminal electrically connected to a third terminal of the second stage,
wherein at least one of the first stage or the second stage comprises a switched capacitor converter circuit including a plurality of semiconductor switches and at least one flying capacitor.

2. The power converter of claim 1, wherein the first stage comprises the switched capacitor circuit and the second stage comprises a pair of semiconductor switches, and wherein the third terminal of the second stage is located between the pair of semiconductor switches of the second stage.

3. The power converter of claim 1, wherein the first stage comprises the switched capacitor circuit and the second stage comprises a pair of diodes, and wherein the third terminal of the second stage is located between the pair of diodes switches of the second stage.

4. The power converter of claim 1, wherein the second stage comprises the switched capacitor circuit and the first stage comprises a pair of semiconductor switches, and wherein the third terminal of the first stage is located between the pair of semiconductor switches of the first stage.

5. The power converter of claim 1, wherein the second stage comprises the switched capacitor circuit and the first stage comprises a pair of didoes, and wherein the third terminal of the first stage is located between the pair of diodes of the first stage.

6. The power converter of claim 1, wherein power converter includes:
a first pair of semiconductor switches comprising a first semiconductor switch and a second semiconductor switch electrically connected to each other at a first electrical connection node; and
a second pair of semiconductor switches comprising a third semiconductor switch and a fourth semiconductor switch electrically connected to each other at a second electrical connection node, wherein the second semiconductor switch is electrically connected to the third semiconductor switch at a third electrical connection node,
wherein the at least one flying capacitor includes a first flying capacitor having a first terminal electrically connected to the first electrical connection node and a second terminal electrically connected to the second electrical connection node.

7. The power converter of claim 6, wherein the power converter further includes:
a fifth semiconductor switch connected to the first semiconductor switch at a fourth electrical connection node; and
a sixth semiconductor switch connected to the fourth semiconductor switch at a fifth electrical connection node,
wherein the at least one flying capacitor further includes a second flying capacitor having a first terminal electrically connected to the fourth electrical connection node and a second terminal electrically connected to the fifth electrical connection node.

8. The power converter of claim 6, wherein the power converter further includes:
a third pair of semiconductor switches comprising a fifth semiconductor switch and a sixth semiconductor switch electrically connected to each other at a fourth electrical connection node, wherein the first semiconductor switch is electrically connected to the sixth semiconductor switch at a fifth electrical connection node; and
a fourth pair of semiconductor switches comprising a seventh semiconductor switch and a eighth semiconductor switch electrically connected to each other at a sixth electrical connection node, wherein the fourth semiconductor switch is electrically connected to the sixth semiconductor switch at a seventh electrical connection node,
wherein the at least one flying capacitor further includes (i) a second flying capacitor having a first terminal electrically connected to the fifth electrical connection node and a second terminal electrically connected to the seventh electrical connection node and (ii) a third flying capacitor having a first terminal electrically connected to the fourth electrical connection node and a second terminal electrically connected to the sixth electrical connection node.

9. The power converter of claim 1, further comprising a control circuit electrically connected to each semiconductor switch and configured to control operation of the semiconductor switches in a plurality of operation modes.

10. A power converter comprising:
a first pair of semiconductor switches comprising a first semiconductor switch and a second semiconductor switch electrically connected to each other at a first electrical connection node;
a second pair of semiconductor switches comprising a third semiconductor switch and a fourth semiconductor switch electrically connected to each other at a second electrical connection node, wherein the second semiconductor switch is electrically connected to the fourth semiconductor switch at a third electrical connection node; and
a piezoelectric-resonator having a first terminal electrically connected to the third electrical connection node and a second terminal electrically coupled to an output terminal of the power converter.

11. The power converter of claim 10, further comprising a capacitor having a first terminal electrically connected to the first electrical connection node and a second terminal electrically connected to the second electrical connection node.

12. The power converter of claim 10, wherein:
the first semiconductor switch includes a source terminal electrically connected to the first electrical connection node and a drain terminal electrically connected to an input terminal of the power converter,
the second semiconductor switch includes a source terminal electrically connected to the third electrical connection node and a drain terminal electrically connected to the first electrical connection node,
the third semiconductor switch includes a source terminal electrically connected to the output terminal of the power converter and a drain terminal electrically connected to the second electrical connection node, and
the fourth semiconductor switch includes a source terminal electrically connected to the second electrical connection node and a drain terminal electrically connected to the third electrical connection node.

13. The power converter of claim 12, further comprising a capacitor having a first terminal electrically connected to the first electrical connection node and a second terminal electrically connected to the second electrical connection node.

14. The power converter of claim 10, further comprising a first diode electrically connected to a second diode at a fourth electrical connection node,
wherein the second terminal of the piezoelectric-resonator is electrically connected to the fourth electrical connection node.

15. The power converter of claim 10, further comprising a control circuit electrically connected to each semiconductor switch and configured to control operation of the semiconductor switches in a plurality of operation modes.

16. The power converter of claim 15, wherein the plurality of operation modes includes a plurality of connected operation modes in which the piezoelectric-resonator is electrically coupled across an input of the power converter, an output of the power converter, or a capacitor of the power converter and a plurality of open operation modes in which the piezoelectric-resonator is not coupled across the input of the power converter, the output of the power converter, or the capacitor of the power converter.

17. The power converter of claim 16, wherein the plurality of connected operation modes comprises at least three connected operation modes and the plurality of open operation modes comprises at least four open operation modes.

18. The power converter of claim 17, wherein:
when in a first connected operation mode, the first semiconductor switch and the fourth semiconductor switch of the power converter are on and the second semiconductor switch and the third semiconductor switch of the power converter are off,
when in a second connected operation mode, the third semiconductor switch and the fourth semiconductor switch of the power converter are on and the first semiconductor switch and the second semiconductor switch of the power converter are off,
when in a third connected operation mode, the second semiconductor switch and the third semiconductor switch of the power converter are on and the first semiconductor switch and the fourth semiconductor switch of the power converter are off, and
when in any of the four open operation modes, each of the first, second, third, and fourth semiconductor switch of the power converter is off.

19. A method for controlling operation of a power converter including a first stage, a second stage and a piezoelectric-resonator, wherein the first stage includes a plurality of semiconductor switches and at least one flying capacitor, the method comprising:
generating, by a controller of the power converter, switching signals at a fixed switching frequency;
supplying, by the controller, the switching signals to at the first stage; and
operating, by the first stage, the plurality semiconductor switches at the fixed switching frequency.

20. The method of claim 19, wherein operating the plurality of semiconductor switches comprises controlling a switching operation of the semiconductor switches in a plurality of operation modes including at least seven connected operation modes in which the piezoelectric-resonator is electrically coupled across an input of the power converter, an output of the power converter, or a capacitor of the power converter and at least five open operation modes in which the piezoelectric-resonator is not coupled across the input of the power converter, the output of the power converter, or the capacitor of the power converter.
